(19) United States
(12) Patent Application Publication
(10) Pub. No.: US 2024/0235965 A1
(43) Pub. Date: Jul. 11, 2024

(54) METHOD, APPARATUS, AND COMPUTER READABLE MEDIUM

(71) Applicant: Rakuten Mobile, Inc., Tokyo (JP)

(72) Inventors: Nitin PAL, Indore (IN); Shivchandra PATHAK, Indore (IN); Pravin MUKATI, Indore (IN); Goutam AGRAWAL, Indore (IN)

(21) Appl. No.: 18/001,716

(22) PCT Filed: Oct. 14, 2022
(86) PCT No.: PCT/US2022/046657

§ 371 Date: Dec. 14, 2022

(51) Int. Cl. H04L 41/5074

(52) U.S. Cl. CPC H04L 41/5074

(57) ABSTRACT

A method includes receiving, by an agent, a complaint of a network issue of a network customer, searching, by the agent, for details of the network customer in a system, finding user location details of the network customer in the system, and displaying, by a customer care web portal in the system, cell site information and coverage information based on the user location details of the network customer. The method further includes determining at least one of a cause of the network issue or a solution of the network issue based on the cell site information and coverage information, and providing details of at least one of the cause of the network issue or the solution of the network issue to the network customer.

### FIELD

The present application relates to a method of analyzing a user's experience of a network based on user data and local shared resources, and an apparatus for analyzing the user's experience of the network based on the user data and the local shared resources.

### BACKGROUND

Network service providers and device manufacturers (e.g., wireless, cellular, etc.) are continually challenged to deliver value and convenience to consumers by, for example, providing compelling network services that are capable of being flexibly constructed, scalable and diverse.

Mobile networks involve the installation of cell sites over an extended geographic area. As the number of users and proliferation of bandwidth intensive services, such as video and music streaming, smart devices, multi-player video gaming, etc., the capacity of particular cell sites increase and often reaches a point the user experience is negatively affected. Cells that are highly utilize lead to network performance issues, such as slower upload/download speeds, latency, and coverage issues.

### SUMMARY

An aspect of this description relates to a method. In some embodiments, the method includes receiving, by an agent, a complaint of a network issue of a network customer, searching, by the agent, for details of the network customer in a system, finding user location details of the network customer in the system, and displaying, by a customer care web portal in the system, cell site information and coverage information based on the user location details of the network customer. The method further includes determining at least one of a cause of the network issue or a solution of the network issue based on the cell site information and coverage information, and providing details of at least one of the cause of the network issue or the solution of the network issue to the network customer.

Another aspect of this description relates to an apparatus that includes a memory having non-transitory instructions stored therein, and a processor coupled to the memory, and being configured to execute the non-transitory instructions, thereby causing the apparatus to receive a complaint of a network issue of a network customer, search for details of the network customer in a system, find user location details of the network customer in the system, and display, by a customer care web portal of the apparatus, cell site information and coverage information based on the user location details of the network customer, determine at least one of a cause of the network issue or a solution of the network issue based on the cell site information and coverage information, and provide details of at least one of the cause of the network issue or the solution of the network issue to the network customer.

Still another aspect of this description relates to a computer-readable medium. In some embodiments, the computer-readable medium includes instructions executable by a controller of a system to cause the system to perform operations including receiving a complaint of a network issue of a network customer, searching for details of the network customer in a system, finding user location details of the network customer in the system, and displaying, by a customer care web portal in the system, cell site information and coverage information based on the user location details of the network customer, determining at least one of a cause of the network issue or a solution of the network issue based on the cell site information and coverage information, and providing details of at least one of the cause of the network issue or the solution of the network issue to the network customer.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a mobile network, in accordance with some embodiments.

FIG. 2 is a block diagram of a system, in accordance with some embodiments.

FIG. 3A is a block diagram of a system, and a flowchart of a method of operating the system, in accordance with some embodiments.

FIG. 3B is a zoomed-in diagram of a customer care web portal of the system of FIG. 3A, in accordance with some embodiments.

FIG. 4 is a flowchart of a method of operating a system, in accordance with some embodiments.

FIG. 5 is a flowchart of a method of operating a system, in accordance with some embodiments.

FIG. 6 is a diagram of a customer care web portal of a system, in accordance with some embodiments.

FIG. 7 is a diagram of a customer care web portal of a system, in accordance with some embodiments.

FIG. 8 is a diagram of a customer care web portal of a system, in accordance with some embodiments.

FIG. 9 is a diagram of a customer care web portal of a system, in accordance with some embodiments.

FIG. 10 is a diagram of a customer care web portal of a system, in accordance with some embodiments.

FIG. 11 is a diagram of a customer care web portal of a system, in accordance with some embodiments.

FIG. 12 is a diagram of a customer care web portal of a system, in accordance with some embodiments.

FIG. 13 is a schematic view of a system, in accordance with some embodiments.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Terms “system” and “network” in embodiments of this application are used interchangeably. “At least one” means one or more, and “a plurality of” means two or more. The term “and/or” describes an association relationship between associated objects and indicates that three relationships exist. For example, A and/or B indicate the following cases: Only A exists, both A and B exist, and only B exists, where A and B is singular or plural. The character “/” generally indicates an “or” relationship between the associated objects. “At least one of” or a similar expression thereof means any combination of items, including any combination of singular items (pieces) or plural items (pieces). For example, “at least one of A, B, and C” includes A, B, C, AB, AC, BC, or ABC, and “at least one of A, B, or C” includes A, B, C, A and B, A and C, B and C, or A and B and C.

Customer support of some approaches has no visibility about customers' real-time network experiences. As a result, customers' real-time network experiences and complaints in some approaches are logged by customer services representatives, and forwarded to a technical team of the network. In some approaches, customer services representatives do not have access to cell site information, cell site coverage information, fault information and congestion information of the customer's location, and therefore the customer services representative cannot perform a first level of troubleshooting based on these parameters.

One or more embodiments of the present disclosure allow customer services representatives (e.g., agents) to have access and to view cell site information, cell site coverage information, fault information and congestion information of the customer's location. Thus, the customer services representative can perform a first level of troubleshooting based on at least cell site coverage information, fault information and congestion information of the customer's location.

One or more embodiments of the present disclosure allows the customer care representative to analyze customers' real-time network experiences. Thus, the customer care representative can access and view fault management (FM) information, performance management (PM) information, cell site coverage information, cell site information and netvelocity (NW) data.

In some embodiments, the present disclosure shows cell sites within a distance of a user location and to identify coverage and VOLTE issues within the distance. In some embodiments, the distance is 500 meters. In some embodiments, the present disclosure displays planned cell sites outages/un-planned outages.

In some embodiments, the present disclosure detects coverage perceptions from the user based on received signal received power (RSRP), signal to noise ratio (SINR) and other NW key performance indicators (KPIs) to provide an initial insight for the customer care representative for the coverage quality in the user area.

In some embodiments, the present disclosure displays coverage, congestion, sites, FM, local shared resources (LSR) and NW data within the distance of the user location, and thereby provides insight for the customer service representative to initially trouble shoot negative network experiences by the customer.

Thus, one or more embodiments of the present disclosure reduces cost, and provides faster resolution time for customers' issues, thereby increasing more customer confidence in the network or telecommunications provider.

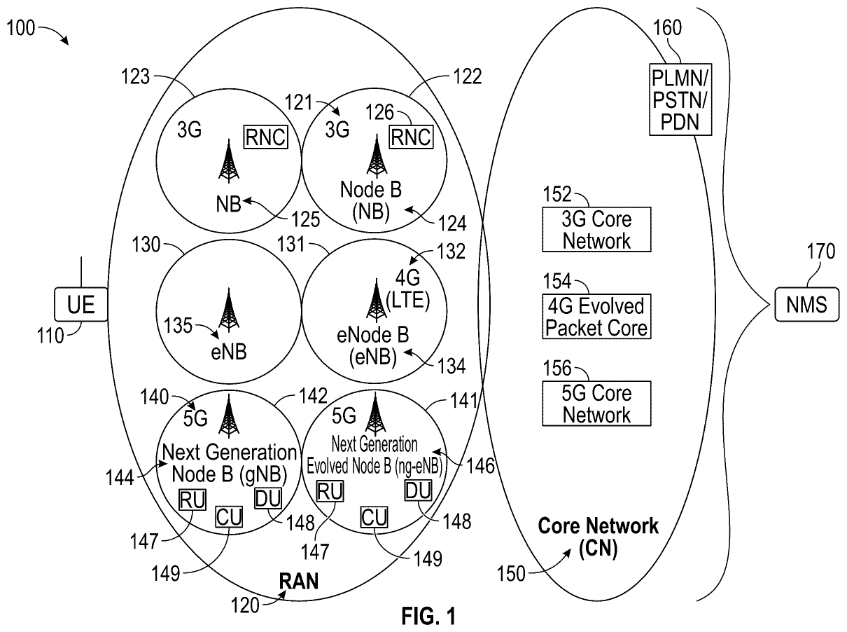

FIG. 1 is a block diagram of a mobile network 100, in accordance with some embodiments.

In FIG. 1, a mobile telecommunication network couples User Equipment (EU) 110 through Radio Access Network (RAN) 120 to a Core Network (CN) 150. RAN 120 connects individual devices, such as User Equipment (EU) 110 to other parts of a network, e.g., CN 150, through radio connections. RAN 120 is responsible for managing radio resources, including strategies and algorithms for controlling power, channel allocation and data rate.

RANs 120 have evolved over time, from 3G to 5G. For example, RANs 120 are implemented in various configurations, such as Global System for Mobile Communications (GSM) RAN (GRAN), GSM Enhanced Data Rates for GSM Evolution (EDGE) RAN (GERAN), Universal Mobile Telecommunications Service (UMTS) Terrestrial RAN (UTRAN), Evolved UMTS Terrestrial RAN (E-UTRAN), Centralized/Cloud RAN (CRAN), Virtualized RAN (VRAN), and Open RAN (ORAN).

In some embodiments, RAN 120 includes one or more of 3G network 121, 4G network 132 or 5G network 140.

In a 3G network 121, RAN 120 includes the base station for Cell Sites 122, 123, which is called a Node B (NB) 124, 125, and a Radio Network Controller (RNC) 126. RNC 126 controls and manages the radio transceivers in Node Bs 124, 125, as well as manages operational functions, such as handoffs, and the radio channels. The RNC 126 handles communication with the 3G Core Network 152.

In a 4G network 132, Cell Sites 130, 131 are implemented using Evolved Node Bs (eNodeBs or eNBs) 134, 135 for the radio base station. The eNodeBs 134, 135 are able to perform the radio access functions that are equivalent to the combined work that Node Bs 124, 125 and RNC do in 3G and connect to the Evolved Packet Core 154.

In a 5G network 140, Cell Sites 141, 142 are implemented using one of two types of RANs: Next Generation Node B (gNodeB) 144 and Next Generation Evolved Node B (ng-eNB) 146. The ng-eNB 146 is an enhanced version of 4G eNodeB and connects 5G UE 110 to the 5G Core Network (5GC) 156 using 4G LTE air interface. The gNB 144 allows 5G UE 110 to connect with a 5GC 156 using 5G NR air interface. The gNBs 144 and ng-eNBs 146 are interconnected by means of the Xn interface. The gNBs 144 and ng-eNBs 146 are also connected by means of the NG interfaces to the 5GC 156.

In 5G, for example, an Open RAN environment is able to be implemented wherein the RAN 120, provided by the gNBs 144 and ng-eNBs 146, is separated into the Radio Unit (RU) 147, the Distributed Unit (DU) 148, and the Centralized Unit (CU) 149. The RU 147 is where the radio frequency signals are transmitted, received, amplified, and digitized. The RU 147 is located near or integrated into, the antenna. The DU 148 and CU 149 are the computation parts of the base station, sending the digitalized radio signal into the network. The DU 148 is physically located at or near the RU 147 whereas the CU 149 is often located near the Core Network 150. The different interfaces associated with the Open RAN 120 include the Fronthaul (FH) that lies between the RU 147 and the DU 148, the Midhaul (MH) that lies between the DU 148 and the CU 149, and the Backhaul (BH) that lies between the CU 149 and the Core Network 150.

Core Network (CN) 150 connects RAN 120 to networks 160, such as a Public Landline Mobile Network (PLMN), a Public Switched Telephone Network (PSTN) and a Packet Data Network (PDN). CN 150 provides high-level traffic aggregation, routing, call control/switching, user authentication and charging. The 3G CN 152 involves two different domains: circuit switched elements and packet switched elements. The 4G Evolved Packet Core (EPC) 154 includes four main network elements: the Serving Gateway (S-GW), the packet data network (PDN) Gateway (P-GW), the mobility management entity (MME), and the Home Subscriber Server (HSS). The S-GW routes and forwards data packets from the UE and acts as the mobility anchor during inter-eNodeB handovers. The P-GW acts as an ingress and egress point to the EPC from a PDN (Packet Data Network) such as the Internet. The MME manages UE access network and mobility, as well as establishing the bearer path for User Equipment (UE). The MME is also concerned with the bearer activation/deactivation process. The HSS is the master database for a given subscriber, acting as a central repository of information for network nodes. Subscriber related information held by the HSS includes user identification, security, location, and subscription profile. The EPC is connected to the external networks, which includes the IP Multimedia Core Network Subsystem (IMS). 5GC 156 supports new network functions (NFs) associated with the packet core and user data management domains. 5GC 156 provides a decomposed network architecture with the introduction of a service-based interface (SBI), and control plane and user plane separation (CUPS). 5GC decomposes the 4G MME into an Access and Mobility Management Function (AMF) and a Session Management Function (SMF). The AMF receives connection and session related information from the UE, but is responsible for handling connection and mobility management tasks. Messages related to session management are forwarded to the SMF.

The mobile network 100 is managed by the network management system (NMS) 170, which provides several network management functionalities. According to at least one embodiment, the NMS 170 provides a customer care representative the real-time network experiences of one or more customers. For example, in some embodiments, the NMS 170 provides the customer care representative FM information, PM information, cell site coverage information, cell site information and NW data of the customer.

There is a maximum number of users that may be accommodated by the mobile network 100 before either the quality or performance of the mobile network 100 is negatively impacted. The carrying capacity of a mobile network 100 is the total amount of data or voice traffic that a cell site, e.g., Cell Sites 122, 123, 130, 131, 141, 142, of the mobile network 100 is able to transfer to and from customers. Wireless data are carried by modulating radio waves. The quantity of waves (or amount of spectrum) a wireless system is allowed to modulate each second is called its bandwidth, and is measured in hertz (Hz). In some embodiments, a signal with a higher bandwidth (i.e., more Hz) can carry more data per second than a signal of lower bandwidth (i.e., less Hz). The total amount of data that a cell site transfers over a given period of time relates to the rate at which Cell Sites 122, 123, 130, 131, 141, 142 transfer data bytes. In some embodiments, a faster cell site will transfer more bytes than a slower cell site. Rates of data transfer are measured in terms of bits per second (bps).

As the number of users increases, so does the amount of traffic that occurs in a given period of time. As a consequence, Cell Sites 122, 123, 130, 131, 141, 142 progressively becomes more and more congested. As a result, the channels of Cell Sites 122, 123, 130, 131, 141, 142 will continue to diminish. According to at least one embodiment, NMS 170 provides the customer care representative congestion information of cell sites so the customer care representative can analyze and troubleshoot customers' real-time network experiences.

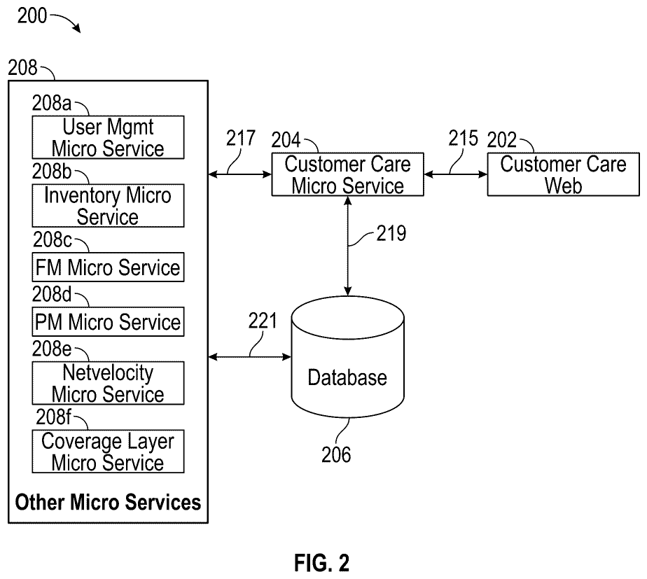

FIG. 2 is a block diagram of a system 200, in accordance with some embodiments.

System 200 includes a customer care web device 202 coupled to a customer care micro service device 204 by a link 215, and the customer care micro service device 204 is coupled to a database 206 by a link 219, and the customer care micro service device 204 is coupled to a device 208 by a link 217, the database 206 is further coupled to a system 208 by a link 221.

System 208 includes at least one or more of a user management micro service 208a, an inventory micro service 208b, an FM micro service 208c, a PM micro service 208d, a netvelocity micro service 208e and a coverage layer micro service 208f.

While FIG. 2 shows user management micro service 208a, inventory micro service 208b, FM micro service 208c, PM micro service 208d, netvelocity micro service 208e and coverage layer micro service 208f as part of system 208, one or more of user management micro service 208a, inventory micro service 208b, FM micro service 208c, PM micro service 208d, netvelocity micro service 208e and coverage layer micro service 208f are not part of system 208 in accordance with some embodiments.

In some embodiments, link 217 includes a plurality of links such that each of user management micro service 208a, inventory micro service 208b, FM micro service 208c, PM micro service 208d, netvelocity micro service 208e and coverage layer micro service 208f is coupled to customer care micro service 204 by a corresponding link or set of links within the plurality of links of link 217.

In some embodiments, link 221 includes a plurality of links such that each of user management micro service 208a, inventory micro service 208b, FM micro service 208c, PM micro service 208d, netvelocity micro service 208e and coverage layer micro service 208f is coupled to database 206 by a corresponding link or set of links within the plurality of links of link 221.

Customer care web device 202 includes one or more devices. In some embodiments, each device in the customer care web device 202 corresponds to a computing device, a computing system or a server. In some embodiments, customer care web device 202 corresponds to a computing device, a computing system or a server.

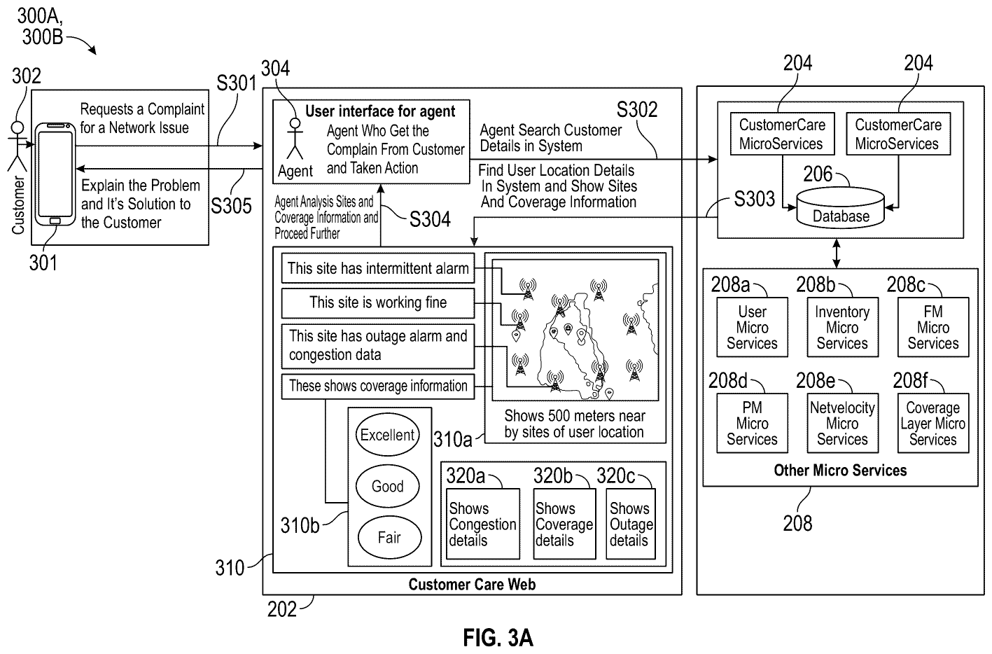

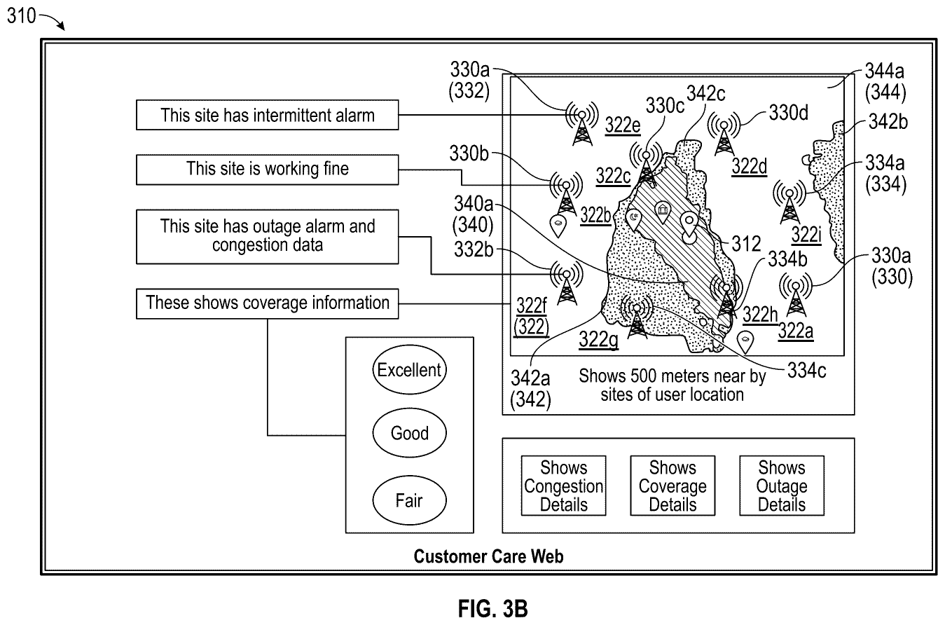

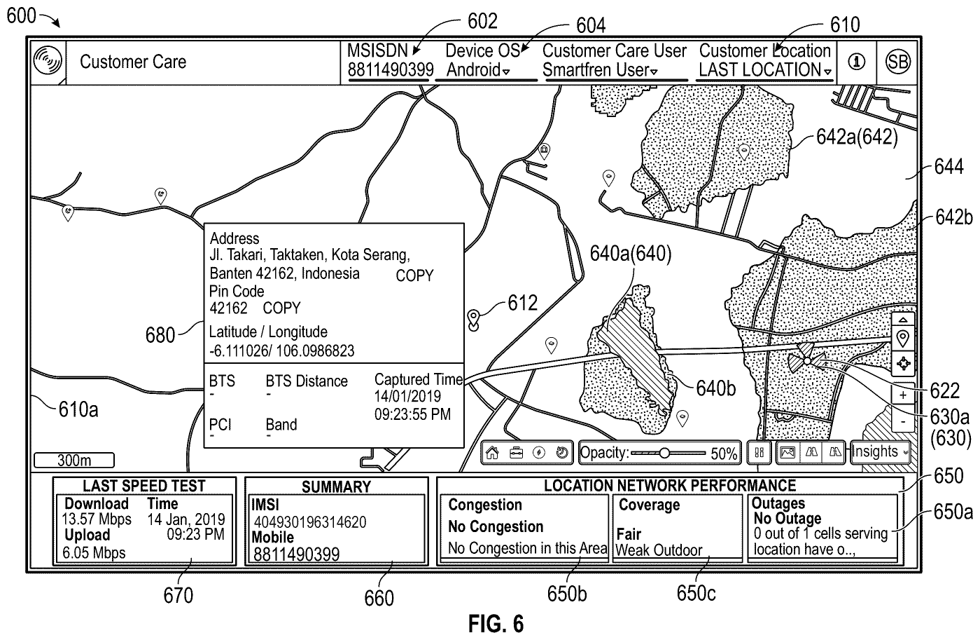

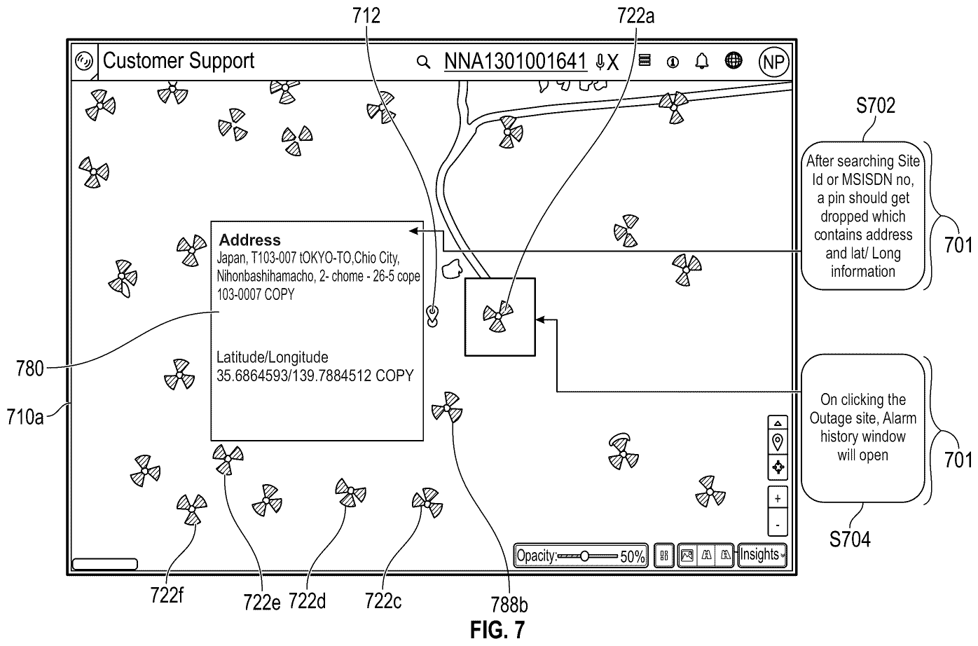

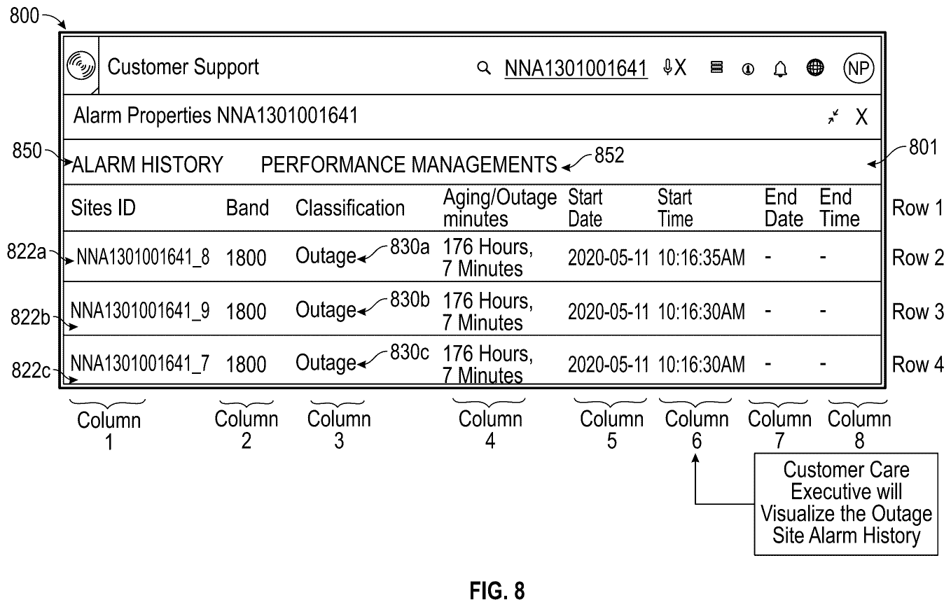

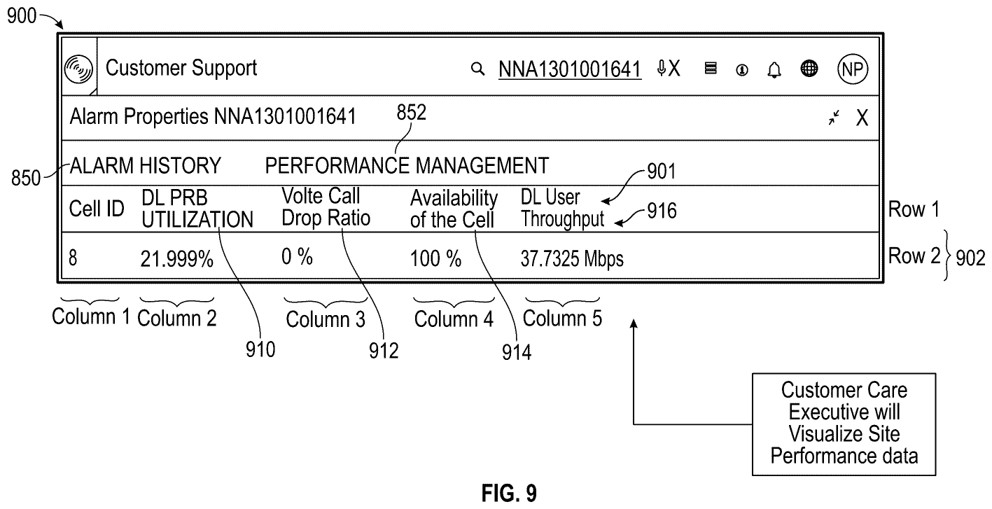

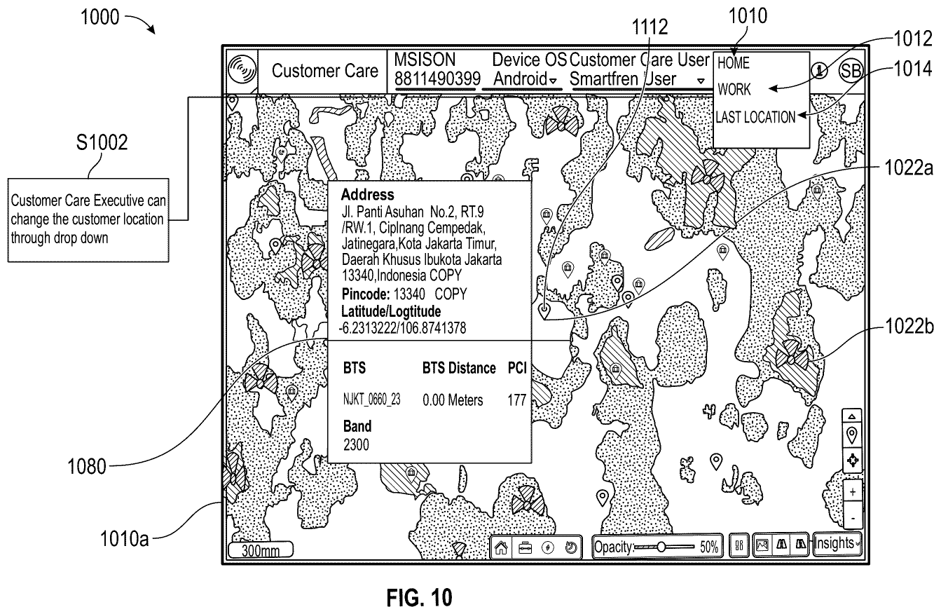

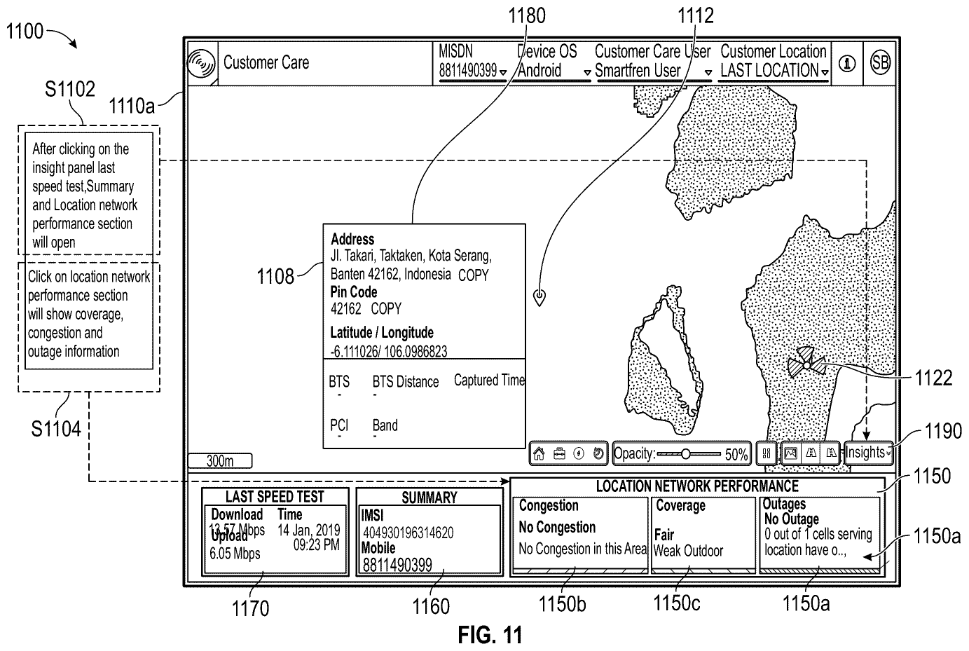

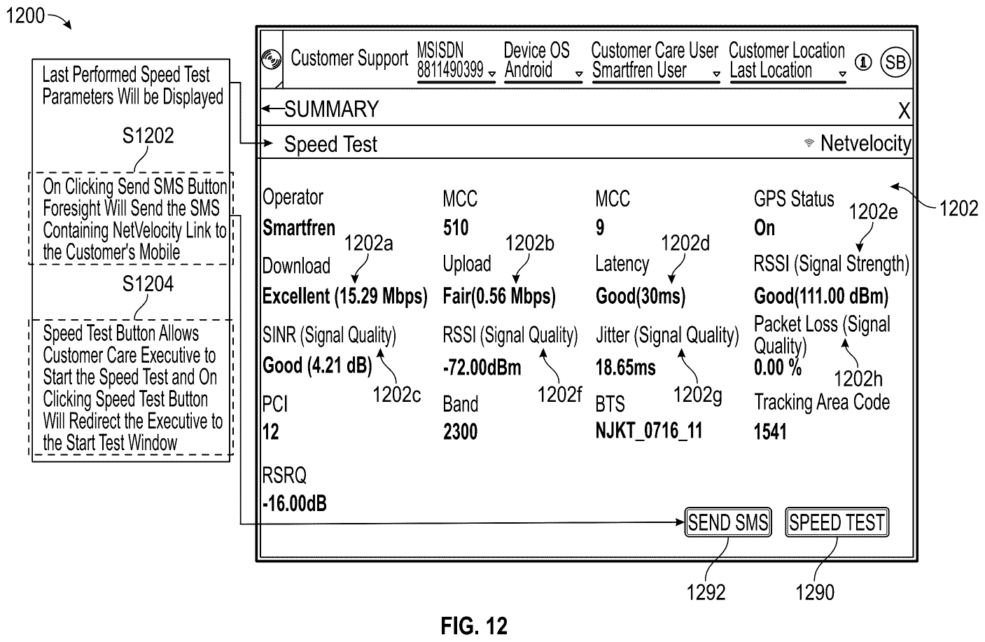

In some embodiments, customer care web device 202 is configured to at least one of generate, display or store a customer care web portal such as at least one of a customer care web portal 310 (FIG. 3), a customer care web portal 600 (FIG. 6), a customer care web portal 700 (FIG. 7), a customer care web portal 800 (FIG. 8), a customer care web portal 900 (FIG. 9), a customer care web portal 1000 (FIG. 10), a customer care web portal 1100 (FIG. 11) or a customer care web portal 1200 (FIG. 12).

Customer care micro service 204 includes one or more devices. In some embodiments, each device in the customer care micro service 204 corresponds to a computing device, a computing system, a server or a data center. In some embodiments, customer care micro service 204 corresponds to a computing device, a computing system, a server or a data center.

In some embodiments, customer care micro service 204 is configured as an interface between customer care web device 202 and at least one of system 208 or database 206.

Customer care micro service 204 is configured to receive a request for cell site information and coverage information of a user location of a network customer (e.g., user) from the customer care web device 202. Customer care micro service 204 is configured to provide the cell site information and coverage information based on user location details of the network customer in response to the request from the customer care web device 202. Customer care micro service 204 is configured to provide the cell site information and coverage information to the customer care web device 202.

Customer care micro service 204 is configured to send requests for user authentication with the user management micro service 208a of the network customer (e.g., user), and is configured to receive a determination whether the user is authenticated (e.g., whether the user is a valid user) by the user management micro service 208a.

Customer care micro service 204 is configured to send requests for cell site data to the inventory micro service 208b, and to receive the requested cell site data from the inventory micro service 208b.

Customer care micro service 204 is configured to send requests for FM data of the cell sites to the FM micro service 208c, and to receive the requested FM data of the cell sites from the FM micro service 208c.

Customer care micro service 204 is configured to send requests for PM data of the cell sites/user to the PM micro service 208d, and to receive the requested PM data of the cell sites/user from the PM micro service 208d. In some embodiments, PM data includes at least one of KPIs of cell sites supporting the user or KPIs of the users data.

Customer care micro service 204 is configured to send requests for NW data of the user to the Netvelocity micro service 208e, and to receive the requested NW data of the user from the Netvelocity micro service 208e.

Customer care micro service 204 is configured to send requests for coverage data of the cell sites to the coverage layer micro service 208f, and to receive the requested coverage data of the cell sites from the coverage layer micro service 208f.

Database 206 is configured to store one or more databases. In some embodiments, the one or more databases stored in database 206 includes one or more of authentication information of one or more users of the network, cell site data of one or more cell sites in the network, FM data of one or more cell sites in the network, PM data of one or more cell sites in the network, NW data of one or more users in the network, or coverage data of one or more cell sites in the network.

In some embodiments, database 206 is divided into separate databases configured to store the corresponding authentication information of one or more users of the network, cell site data of one or more cell sites in the network, FM data of one or more cell sites in the network, PM data of one or more cell sites in the network, NW data of one or more users in the network, or coverage data of one or more cell sites in the network.

Database 206 includes an organized collection of data or structured information that is stored in database storage device 206. In some embodiments, database 206 is a non-relational database. In some embodiments, database 206 is a relational database that is configured to use Structured Query Language (SQL).

User management micro service 208a includes one or more devices. In some embodiments, each device in the user management micro service 208a corresponds to a computing device, a computing system, a server or a data center. In some embodiments, user management micro service 208a corresponds to a computing device, a computing system, a server or a data center.

User management micro service 208a is configured to receive requests for user authentication of the network customer (e.g., user) from the customer care micro service 204, is configured to determine whether the user is authenticated (e.g., whether the user is a valid user), and is configured to send the determination whether the user is authenticated (e.g., whether the user is a valid user) to the customer care micro service 204.

Inventory micro service 208b includes one or more devices. In some embodiments, each device in the inventory micro service 208b corresponds to a computing device, a computing system, a server or a data center. In some embodiments, inventory micro service 208b corresponds to a computing device, a computing system, a server or a data center.

Inventory micro service 208b is configured to receive requests for cell site data of the user from the customer care micro service 204, and is configured to send the requested cell site data of the user to the customer care micro service 204.

FM micro service 208c includes one or more devices. In some embodiments, each device in the FM micro service 208c corresponds to a computing device, a computing system, a server or a data center. In some embodiments, FM micro service 208c corresponds to a computing device, a computing system, a server or a data center.

FM micro service 208c is configured to receive requests for FM data of the cell sites from the customer care micro service 204, and to send the requested FM data of the cell sites to the customer care micro service 204.

PM micro service 208d includes one or more devices. In some embodiments, each device in the PM micro service 208d corresponds to a computing device, a computing system, a server or a data center. In some embodiments, PM micro service 208d corresponds to a computing device, a computing system, a server or a data center.

PM micro service 208d is configured to receive requests for PM data of the cell sites from the customer care micro service 204, and to send the requested PM data of the cell sites to the customer care micro service 204.

Netvelocity micro service 208e includes one or more devices. In some embodiments, each device in the inventory micro service 208e corresponds to a computing device, a computing system, a server or a data center. In some embodiments, inventory micro service 208e corresponds to a computing device, a computing system, a server or a data center.

Netvelocity micro service 208e is configured to receive requests for NW data of the user from the customer care micro service 204, and to send the requested NW data of the user to the customer care micro service 204.

Coverage layer micro service 208f includes one or more devices. In some embodiments, each device in the coverage layer micro service 208f corresponds to a computing device, a computing system, a server or a data center. In some embodiments, coverage layer micro service 208f corresponds to a computing device, a computing system, a server or a data center.

Coverage layer micro service 208f is configured to send requests for coverage data of the cell sites from the customer care micro service 204, and to send the requested coverage data of the cell sites to the customer care micro service 204.

In some embodiments, the coverage layer micro service 208f includes a smart network coverage layer (SNC). In some embodiments, the SNC layer is configured to merge at least two types of coverage data. For example, in some embodiments, the SNC layer is configured to merge (1) predicted coverage data and (2) drive test data. In some embodiments, the predicted coverage data is generated by a wireless network design and optimization platform configured to support wireless operators. In some embodiments, the predicted coverage data is generated by a RF planning software application. In some embodiments, the predicted coverage data is generated by Atol. In some embodiments, the drive test data is captured by the net velocity micro service 208e. In some embodiments, the SNC layer is configured to generate coverage data based on the average between (1) predicted coverage data and (2) drive test data. In some embodiments, the SNC layer is configured to generate coverage data based on a weighted average between (1) predicted coverage data and (2) drive test data. Different weights are within the scope of the present disclosure.

In some embodiments, the coverage data generated by the SNC layer includes at least one of the SINR or the RSRP received by the UE 110 from cell sites 322 in FIG. 3. In some embodiments, other types of data are used to generate the coverage data.

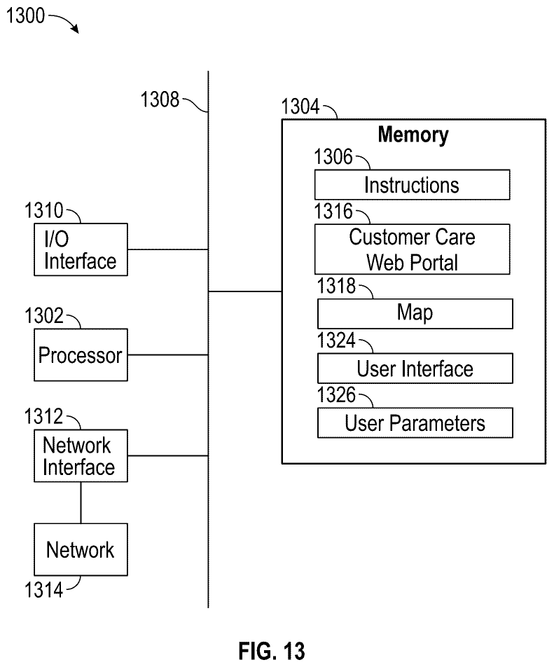

In some embodiments, system 1300 of FIG. 13 (described below) corresponds to at least one or more of customer care web device 202, customer care micro service device 204, database 206, system 208, user management micro service 208a, inventory micro service 208b, FM micro service 208c, PM micro service 208d, netvelocity micro service 208e or coverage layer micro service 208f, and similar detailed description is therefore omitted.

In some embodiments, system 1300 (FIG. 13) is an embodiment of one or more of customer care web device 202, customer care micro service device 204, database 206, system 208, user management micro service 208a, inventory micro service 208b, FM micro service 208c, PM micro service 208d, netvelocity micro service 208e or coverage layer micro service 208f.

In some embodiments, at least two or more of customer care web device 202, customer care micro service device 204, database 206, system 208, user management micro service 208a, inventory micro service 208b, FM micro service 208c, PM micro service 208d, netvelocity micro service 208e or coverage layer micro service 208f are part of a same network as each other.

In some embodiments, at least one or more of customer care web device 202, customer care micro service device 204, database 206, system 208, user management micro service 208a, inventory micro service 208b, FM micro service 208c, PM micro service 208d, netvelocity micro service 208e or coverage layer micro service 208f is part of a different corresponding network from each other.

In some embodiments, at least the same network or the different network corresponds to a wired or wireless network. In some embodiments, at least the same network or the different network corresponds to a local area network (LAN). In some embodiments, at least the same network or the different network corresponds to a wide area network (WAN). In some embodiments, at least the same network or the different network corresponds to a metropolitan area network (MAN). In some embodiments, at least the same network or the different network corresponds to an internet area network (IAN), a campus area network (CAN) or a virtual private networks (VPN). In some embodiments, at least the same network or the different network corresponds to the Internet.

Other configurations, number of networks or different types of network in at least the same network or the different network are within the scope of the present disclosure.

In some embodiments, at least link 215, 217, 219 or 221 is a wired link. In some embodiments, at least link 215, 217, 219 or 221 is a wireless link. In some embodiments, at least link 215, 217, 219 or 221 corresponds to any transmission medium type; e.g. fiber optic cabling, any wired cabling, and any wireless link type(s). In some embodiments, at least link 215, 217, 219 or 221 corresponds to shielded, twisted-pair cabling, copper cabling, fiber optic cabling, and/or encrypted data links.

In some embodiments, at least link 215, 217, 219 or 221 is based on different technologies, such as code division multiple access (CDMA), wideband CDMA (WCDMA), time division multiple access (TDMA), frequency division multiple access (FDMA), Orthogonal Frequency Division Multiplexing (OFDM), time division duplexing (TDD), frequency division duplexing (FDD), Bluetooth, Infrared (IR), or the like, or other protocols that may be used in a wireless communications network or a wired data communications network. Accordingly, the exemplary illustrations provided herein are not intended to limit the embodiments of the disclosure and are merely to aid in the description of aspects of the embodiments of the disclosure.

Other configurations or number of links in at least in link 215, 217, 219 or 221 are within the scope of the present disclosure. For example, while FIG. 2 shows a single link for each of link 215, 217, 219 or 221, one or more of links 215, 217, 219 or 221 include a plurality of links.

Other configurations, different types of devices or other number of devices in customer care web device 202, customer care micro service device 204, database 206, system 208, user management micro service 208a, inventory micro service 208b, FM micro service 208c, PM micro service 208d, netvelocity micro service 208e or coverage layer micro service 208f are within the scope of the present disclosure.

Other configurations or number of elements in system 200 are within the scope of the present disclosure.

FIG. 3A is a block diagram of a system 300A, and a flowchart of a method 300B of operating the system 300A, in accordance with some embodiments.

FIG. 3B is a zoomed-in diagram of a customer care web portal 310 of system 300A of FIG. 3A, in accordance with some embodiments.

System 300A is an embodiment of system 200 and system 100, and similar detailed description is omitted.

System 300A includes system 200 of FIG. 2 and a UE 110 of FIG. 1, and similar detailed description is therefore omitted. A user (e.g., customer) 302 is configured to use the UE 110. An agent (e.g., customer care representative) 304 is configured to use the customer care web device 202 thereby causing the customer care web device 202 to generate a customer care web portal 310. Customer care web device 202 includes a customer care web portal 310. In some embodiments, the customer care web portal 310 includes a map region 310a, a color key 310b of the coverage data, a congestion details field 320a, a coverage details field 320b and an outage details field 320c. Other fields in the customer care web portal 310 are within the scope of the present disclosure.

In some embodiments, customer care web portal 310 is viewable by a user by way of a user interface (e.g., user interface 1324 in FIG. 13), and is displayed by system 1300.

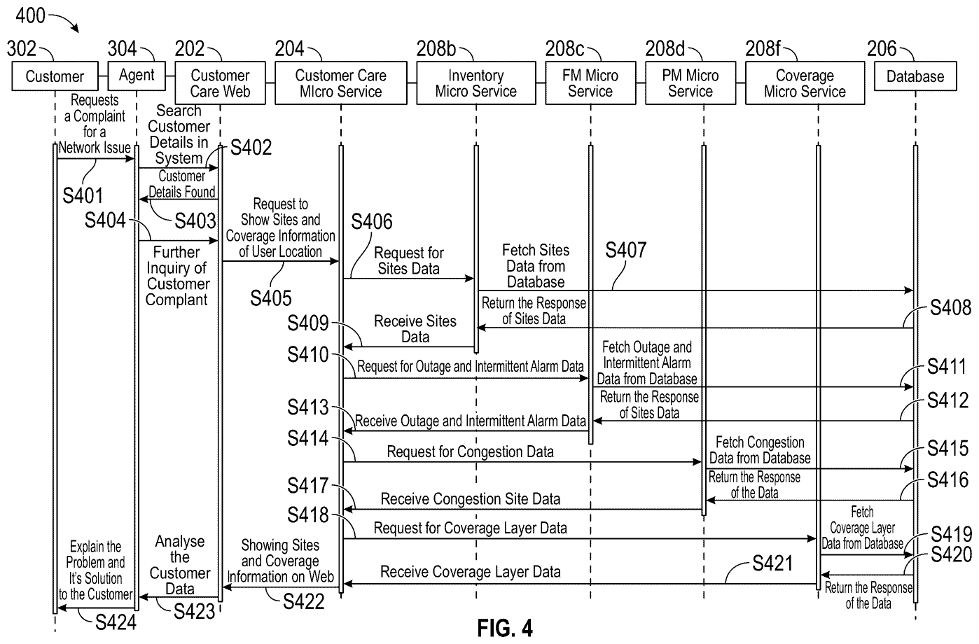

In some embodiments, the customer care web device 202 is configured to interact with at least one or more of customer care micro service device 204, database 206, system 208, user management micro service 208a, inventory micro service 208b, FM micro service 208c, PM micro service 208d, netvelocity micro service 208e or coverage layer micro service 208f as described in FIG. 2 or FIG. 4 (described below), and similar detailed description is therefore omitted.

Method 300B includes a series of steps or operations (e.g., S301, S302, S303, S304 and S305), performed by system 300A.

In some embodiments, method 300B is a method of analyzing an experience of a user 302 of a network based on Netvelocity data of the user 302 and local shared resources. In some embodiments, at least portions of method 300B are performed by at least one or more of customer care micro service device 204, database 206, system 208, user management micro service 208a, inventory micro service 208b, FM micro service 208c, PM micro service 208d, netvelocity micro service 208e, coverage layer micro service 208f or UE 110.

In some embodiments, FIG. 3A is a flowchart of a method 300B of operating system 300A of FIG. 3A, and similar detailed description is therefore omitted. It is understood that additional operations may be performed before, during, and/or after the method 300B depicted in FIG. 3A, and that some other operations may only be briefly described herein. In some embodiments, other order of operations of method 300B is within the scope of the present disclosure. In some embodiments, one or more operations of method 300B are not performed.

Method 300B includes exemplary operations, but the operations are not necessarily performed in the order shown. Operations may be added, replaced, changed order, and/or eliminated as appropriate, in accordance with the spirit and scope of disclosed embodiments. It is understood that method 300B utilizes features of one or more of system 100, 200 or 300A.

In operation S301 of method 300B, receiving a complaint of a network issue of a network customer (e.g., user 302). In some embodiments, the complaint of the network issue of the network customer is received by agent 304 from the user 302.

In some embodiments, the complaint of the network issue includes inability of the user 302 to make a voice call, a video call, a conference call, send/receive email, send/receive a text message or the like. In some embodiments, the complaint of the network issue includes inability of the user 302 to reach a web page. In some embodiments, the complaint of the network issue includes slow internet speed, slow data transfer speed, network timeouts, poor signal quality, inability for the user 302 to launch one or more software applications on the UE 110, one or more software applications on the UE 110 are operating slower than normal or expected, inability for the user 302 to use one or more hardware applications on the UE 110, one or more hardware applications on the UE 110 are operating slower than normal or expected, unexpected behavior of the UE 110 or the like. Other network complaints are within the scope of the present disclosure.

In operation S302 of method 300B, searching for details of the network customer in at least a system (e.g., system 200) or a database 206. In some embodiments, the details of the network customer are searched by the agent 304. In some embodiments, the details of the network customer are searched by the agent 304 in system 200 or database 206.

In some embodiments, the details of the network customer include one or more of a Mobile Station Integrated Services Digital Network (MSISDN) 602 (FIG. 6) or a user location 312. In some embodiments, the MSISDN 602 is a phone number which identifies the UE 110 by the network 100 or 300A. Other details of the network customer are within the scope of the present disclosure.

In operation S303 of method 300B, user location details 610 (FIG. 6) of the network customer are found in the system, and cell site information and coverage information of the user location are displayed in a customer care web portal 306. In some embodiments, the cell site information and coverage information of the user location are displayed in the map region 310a of the customer care web portal 306. In some embodiments, operation S303 of method 300B comprises the customer care web device 202 requesting cell sites and coverage information of the user location 312/user location details 610 from the customer care micro service 204.

In some embodiments, operation S303 includes the customer care web portal generating a map (e.g., map region 310a) based on the users location, and dropping a pin on the map to signify the user's location 312.

In some embodiments, operation S303 of method 300B comprises finding user location details in the system, and displaying the cell site information and coverage information based on the user location details.

In some embodiments, the map region 310a displays graphical details of the cell site information and coverage information of the user location. In some embodiments, the map region 310a is generated by the customer care web portal 306. In some embodiments, the map region 310a is generated by one or more devices in system 208 or customer care micro service 204. In some embodiments, the user location details of the network customer include the latitude and longitude of the network customer.

In some embodiments, the user location details 610 of the network customer include the users location 312. In some embodiments, the user location details 610 of the network customer include at least one of the latitude and longitude of the last location 1014 (FIG. 10) of the network customer, the latitude and longitude of the home location 1010 of the network customer, or the latitude and longitude of the work location 1012 of the network customer.

Other user location details 610 of the network customer are within the scope of the present disclosure.

In some embodiments, at least one of the user location details 610 of the network customer or the cell site information and coverage information of the user location 312 of the network customer are found in the database 206.

In some embodiments, the user location details 610 of the network customer are found based on the MSISDN 602. In some embodiments, the cell site information and coverage information of the user location 312 are based on the user location details of the network customer.

In some embodiments, the cell site information includes cell site data of the user 302 based on the users location 312. In some embodiments, the cell site information includes a list of current cell sites and planned cell sites based on the users location 312. In some embodiments, the cell site data of the user 302 based on the users location 312 includes the cell sites 322 that are located within a first distance DI of the users location 312. In some embodiments, the first location DI is equal to 500 meters. In some embodiments, the cell sites 322 includes one or more of cells 322a, . . . , 322h or 322i. Other values for the first distance DI of within the scope of the present disclosure. In some embodiments, the cell site data of the user 302 includes a list of current cell sites and planned cell sites based on the users location 312.

In some embodiments, the coverage information of the user location 312 include one or more of FM data of the cell sites 322 that are located within the first distance DI of the users location 312, PM data of the cell sites 322 that are located within the first distance DI of the users location 312, NW data of the UE 110 or coverage data of the cell sites 322 that are located within the first distance DI of the users location 312.

In some embodiments, FM data of the cell sites includes FM data 702 or table 802. In some embodiments, FM data 702 or table 802 includes fault management data. In some embodiments, FM data 702 includes one or more outage alarms of one or more cell sites 322. In some embodiments, each cell site 322 has a corresponding outage alarm. In some embodiments, the outage alarm identifies whether or not the corresponding cell site has an outage.

In some embodiments, the outage alarms include one or more cell sites with no outages, one or more cell with an outage in the last 24 hours, and one or more cell with an active outage. In some embodiments, the cell sites 322a-322i have corresponding outage alarms 330a-330d, 332a, 332b, 334a-334c that are color coded based on a white color, a yellow color and a red color. In some embodiments, the white color corresponds to cell sites 322a, 322b, 322c and 322d that have no current outages. In some embodiments, the yellow color corresponds to cell sites 322e and 322f that do not have an active outage, but have had outages in the last 24 hours. In some embodiments, the red color corresponds to cell sites 322g, 322h and 322i that have active outages

Other types of color designations or tier designations to signify outage alarm types are within the scope of the present disclosure. Other numbers of types of color designations or tier designations to signify outage alarm types are within the scope of the present disclosure.

For example, cell sites 322a, 322b, 322c and 322d have no current outages. In some embodiments, cell sites 322a, 322b, 322c and 322d are designated by corresponding outage alarms 330a, 330b, 330c, 330d (e.g., no outages).

For example, cell sites 322e and 322f do not have an active outage, but have had outages in the last 24 hours. In some embodiments, cell sites 322e and 322f are designated by corresponding outage alarms 332a and 332b (e.g., outages in the last 24 hours).

For example, cell sites 322g, 322h and 322i have active outages. In some embodiments, cell sites 322g, 322h and 322i designated by the outage alarms 334a, 334b and 334c (e.g., active outage).

Other time windows for outages of cell sites or FM data 702 are within the scope of the present disclosure.

In some embodiments, PM data 902 includes KPIs of one or more cell sites 322 or the UE 110. In some embodiments, PM data 902 includes congestion information of one or more cell sites 322. In some embodiments, PM data 902 includes whether the current cell site is congested. In some embodiments, the congestion information or the PM data 902 of one or more cell sites 322 includes Downlink (DL) Physical Resource Block (PRB) Utilization parameter 910, VOLTE call drop ratio parameter 912, availability of the cell parameter 914, DL user throughput parameter 916 (shown in FIG. 9).

Other types of data or parameters for PM data 902 are within the scope of the present disclosure.

In some embodiments, NW data 1202 includes download speed 1202a, upload speed 1202b, SINR 1202c, latency 1202d, RSRP 1202e, RSSI 1202f, Jitter 1202g, packet loss 1202h or the like.

In some embodiments, the NW data 1202 is obtained by the UE 110 performing a speed test by the use of the NW application.

In some embodiments, at least one of coverage data 340, 342 or 344 includes at least the SINR or the RSRP received by the UE 110 from the cell sites 322. In some embodiments, other types of data are used to generate the coverage data.

In some embodiments, the agent 304 can select the type of coverage data that is used by the SNC layer in order to generate the coverage data. For example, the agent 304 can select the SINR received by the UE 110 from the cell sites 322 as the type of coverage data that is used by the SNC layer in order to generate the coverage data, in accordance with some embodiments. For example, the agent 304 can select the RSRP received by the UE 110 from the cell sites 322 as the type of coverage data that is used by the SNC layer in order to generate the coverage data, in accordance with some embodiments.

In some embodiments, coverage data 340, 342 or 344 is generated by the SNC layer based on the average between (1) predicted coverage data and (2) drive test data. In some embodiments, coverage data 340, 342 or 344 is generated by the SNC layer based on a weighted average between (1) predicted coverage data and (2) drive test data. Different weights are within the scope of the present disclosure.

In some embodiments, the coverage data 340, 342 and 344 can be divided into tiers, and each tier corresponds to a level of signal quality. For example, coverage data 340 corresponds to an “excellent” coverage region, coverage data 342 corresponds to a “good” coverage region, and coverage data 344 corresponds to a “poor” coverage region, in accordance with some embodiments. In some embodiments, the “excellent” coverage region has a higher SINR or RSRP than the SINR or RSRP of the “good” coverage region. In some embodiments, the “good” coverage region has a higher SINR or RSRP than the SINR or RSRP of the “poor” coverage region.

In some embodiments, the coverage data 340, 342 and 344 are color coded based on a color key 310b.

Coverage data 340 includes coverage data region 340a.

Coverage data 342 includes coverage data regions 342a, 342b and 342c.

Coverage data 344 includes coverage data region 344a.

In some embodiments, the coverage data 340, 342 and 344 can be sub-divided into different categories based on the user location. For example, the coverage quality in the user area can be categorized as “Good Indoor/Bad Outdoor” where the coverage quality when the user is located indoors is good or better than when the user is located outdoors and is bad, in accordance with some embodiments. For example, the coverage quality in the user area can be categorized as “Good Indoor/Good Outdoor” where the coverage quality when the user is located indoors is good and approximately equal to when the user is located outdoors and is good, in accordance with some embodiments. For example, the coverage quality in the user area can be categorized as “Bad Indoor/Good Outdoor” where the coverage quality when the user is located indoors is bad or worse than when the user is located outdoors and is good, in accordance with some embodiments. Other subcategories or other numbers of coverage quality are within the scope of the present disclosure.

Other numbers of at least one of coverage data 340, 342 or 344 or coverage regions are within the scope of the present disclosure.

In operation S304 of method 300B, the cell site information and coverage information is analyzed. In some embodiments, the agent 304 analyzes the cell site information and coverage information. In some embodiments, operation S304 includes determining at least one of a cause of the network issue or a solution of the network issue based on the cell site information and coverage information.

In some embodiments, determining at least one of the cause of the network issue includes clicking the show congestion details field 320a, show coverage details field 320b or show outage details field 320c in the customer care web portal 310.

In some embodiments, by the agent 304 clicking the show congestion details field 320a in the customer care web portal 310, the customer care web portal 310 displays the PM data 902 in the map region 310a, and the agent 304 is able to determine a solution of the network issue based on the cell site information and coverage information. In some embodiments, if the agent 304 determines that congestion is the cause of the network issue, then the agent 304 informs the user 302 that the congestion problem will be resolved within a specified time period, or that expansion of the network is planned which will solve the congestion problem.

In some embodiments, by the agent 304 clicking the show coverage details field 320b in the customer care web portal 310, the customer care web portal 310 displays the coverage data 340, 342 and 344 in the map region 310a, and the agent 304 is able to determine a solution of the network issue based on the cell site information and coverage information.

In some embodiments, if the agent 304 determines that coverage is the cause of the network issue, then the agent 304 informs the user 302 that the coverage problem will be resolved by installing one or more new cell sites in the network that will more better coverage to the user 302, and the one or more new cell sites are planned to be installed in the network.

In some embodiments, by the agent 304 clicking the show outage details 320c in the customer care web portal 310, the customer care web portal 310 displays the FM data 702 in the map region 310a, and the agent 304 is able to determine a solution of the network issue based on the cell site information and coverage information.

In some embodiments, if the agent 304 determines that outage is the cause of the network issue, then the agent 304 informs the user 302 that the outage problem will be resolved within a specified time period for cell sites that have an active outage, such as cell sites 322g, 322h and 322i, or that the outage problem has been resolved by cell sites that are no longer experiencing an outage for cell sites that do not have an active outage, but have had outages in the last 24 hours such as cell sites 322e and 322f.

In operation S305 of method 300B, details of at least one of the cause of the network issue or the solution of the network issue are provided to the network customer. In some embodiments, operation S305 includes the agent 304 explaining at least one of the cause of the network issue or the solution of the network issue to the network customer based on the analysis of the cell site information and coverage information.

For example, in some embodiments, agent 304 explains to the network customer that the agent 304 can see an ongoing cell site outage near the user's location, and the agent 304 can tell the network customer that cell site outage will be resolved within the next 24 to 72 hours, thereby providing a first level of troubleshooting to the network customer.

For example, in some embodiments, agent 304 explains to the network customer that the agent 304 can see an ongoing congestion issue at one or more cell sites near the user's location, and the agent 304 can tell the network customer that the ongoing congestion issue will be resolved within the next 24 to 72 hours, thereby providing a first level of troubleshooting to the network customer.

For example, in some embodiments, agent 304 explains to the network customer that the agent 304 can see an ongoing congestion issue at one or more cell sites near the user's location, and the agent 304 can tell the network customer that the ongoing congestion issue will be resolved soon by installing additional cell sites or network expansion, thereby providing a first level of troubleshooting to the network customer.

In some embodiments, agent 304 can instruct the network customer to perform a NW speed test, thereby providing a first level of troubleshooting to the network customer. In some embodiments, the results of the speed test are shared with the customer web portal 1200 as shown in FIG. 12, and the agent 304 can use the speed test results to provide a solution to the network customer.

In some embodiments, the network user may have a problem with their headset or the UE 110, and the agent 304 can tell the network customer to go to a store that is closest to the user's location shown in the customer care web portal, thereby providing a first level of troubleshooting to the network customer.

In some embodiments, the agent 304 may not find a cause of the problem of the network customer or may not have a plausible solution, and the agent can create a ticket which will be handled by the next level of troubleshooting for the network customer.

In some embodiments, at least one of operation S301, S302, S304 or S305 is performed by a human user. In some embodiments, the performance of S301, S302, S304 or S305 is automated, and S301, S302, S304 or S305 is performed by a system such as system 1300 of FIG. 13.

In some embodiments, portions of at least one of operation S301, S302, S304 or S305 is performed by a human user. In some embodiments, portions of the performance of S301, S302, S304 or S305 is automated, and the portions of S301, S302, S304 or S305 is performed by a system such as system 1300 of FIG. 13.

In some embodiments, by using method 200, customer services representatives (e.g., agents) have access and can view cell site information, cell site coverage information, fault information and congestion information of the customer's location. Thus, the customer services representative can perform a first level of troubleshooting based on at least cell site coverage information, fault information and congestion information of the customer's location.

In some embodiments, by using method 200, the customer care representative can analyze customers' real-time network experiences. Thus, the customer care representative can access and view fault management (FM) information, performance management (PM) information, cell site coverage information, cell site information and netvelocity (NW) data.

In some embodiments, by using method 200, coverage perceptions from the user are detected based on received signal received power (RSRP), signal to noise ratio (SINR) and other NW key performance indicators (KPIs) to provide an initial insight for the customer care representative for the coverage quality in the user area.

In some embodiments, by using method 200, coverage, congestion, sites, FM, local shared resources (LSR) and NW data within the distance of the user location are displayed, and method 200 thereby provides insight for the customer service representative to initially trouble shoot negative network experiences by the customer.

Thus, method 200 reduces cost, and provides faster resolution time for customers' issues, thereby increasing more customer confidence in the network or telecommunications provider.

FIG. 4 is a flowchart of a method 400 of operating a system, in accordance with some embodiments.

Method 400 is an embodiment of method 300B of FIG. 3A, and similar detailed description is omitted. In some embodiments, one or more of operations S401-S424 is an embodiment of one or more of operations S301-S305 of method 300B, and similar detailed description is therefore omitted.

In some embodiments, method 400 includes a series of steps or operations (e.g., S401-S4424) performed by system 100, 200 or 300A.

Method 400 is an embodiment of at least operations S301, S302, S303, S304 or S305 of method 300B of FIG. 3A, and similar detailed description is therefore omitted. For example, in some embodiments, method 400 is a method of analyzing an experience of a user 302 of a network based on Netvelocity data of the user 302 and local shared resources.

In some embodiments, FIG. 4 is a flowchart of a method 400 of operating system 100 of FIG. 1, system 200 of FIG. 2 or system 300A of FIG. 3A, and similar detailed description is therefore omitted. It is understood that additional operations may be performed before, during, and/or after the method 400 depicted in FIG. 4, and that some other operations may only be briefly described herein. In some embodiments, other order of operations of method 400 is within the scope of the present disclosure. In some embodiments, one or more operations of method 400 are not performed.

Method 400 includes exemplary operations, but the operations are not necessarily performed in the order shown. Operations may be added, replaced, changed order, and/or eliminated as appropriate, in accordance with the spirit and scope of disclosed embodiments. It is understood that method 400 utilizes features of one or more of system 100, 200 or 300A or method 300B.

In operation S401 of method 400, receiving, by an agent 304, a complaint of a network issue of a network customer 302. In some embodiments, operation S401 is operation S301 of method 300B, and similar detailed description is therefore omitted.

In operation S402 of method 400, the agent 304 searches for details of the network customer 302 in a customer care web portal of the customer care web device 202. In some embodiments, the customer care web portal of the customer care web device 202 includes customer care web portal 310, customer care web portal 600 (FIG. 6), customer care web portal 700 (FIG. 7), customer care web portal 800 (FIG. 8), customer care web portal 900 (FIG. 9), customer care web portal 1000 (FIG. 10), customer care web portal 1100 (FIG. 11) or customer care web portal 1200 (FIG. 12).

In some embodiments, in operation S402, the agent 304 searches for details of the network customer 302 in a system, such as system 200 or in user management micro service 208a. In some embodiments, the agent 304 searches for the network customer by entering the MSISDN 602 of the network customer in the customer care web portal (e.g., customer care web portal 600).

In some embodiments, the details of the network customer include one or more of a Mobile Station Integrated Services Digital Network (MSISDN) 602 (FIG. 6), a user location 312 or a phone type OS 604. In some embodiments, the MSISDN 602 is a phone number which identifies the UE 110 by the network 100 or 300A. Other details of the network customer are within the scope of the present disclosure.

In some embodiments, operation S402 includes operation S302 of method 300B, and similar detailed description is therefore omitted.

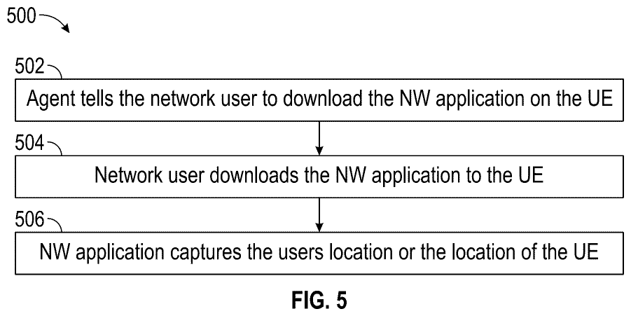

In operation S403 of method 400, the agent 304 receives the details of the network customer 302 from the customer care web portal. In some embodiments, the agent 304 cannot find the details of the network customer 302 from the customer care web portal, and the agent 304 performs at least method 500 of FIG. 5, and similar detailed description is therefore omitted.

In some embodiments, operation S403 includes the customer care web portal generating a map based on the users location, dropping a pin on the map to signify the user's location.

In operation S404 of method 400, the agent 304 performs a further inquiry of the customer complaint. In some embodiments, operation S404 includes the agent 305 determining at least one of a cause of the network issue or a solution of the network issue by use of the customer care web portal. In some embodiments, operation S404 includes determining at least one of a cause of the network issue or a solution of the network issue.

In some embodiments, operation S404 includes operation S405. In some embodiments, operation S404 includes at least one of operation S302, S303, S304 or S305.

In operation S405 of method 400, the customer care web device 202 requests to show cell sites and coverage information of the user location 312/user location details 610 from the customer care micro service 204. In some embodiments, operation S405 is caused by a request from the agent 304 which causes the customer care web device 202 request to show cell sites and coverage information of the user location 312/user location details 610.

In some embodiments, one or more of operations S405, S406, S407, S408, S409, S410 S411, S412, S413, S414, S415, S416, S417, S418, S419, S420, S421 or S422 is an embodiment of operation S303 of method 300B, and similar detailed description is therefore omitted.

In some embodiments, operation S405 comprises the customer care web portal sending a request to display cell sites and coverage information of the user location from the customer care micro services. In some embodiments, the cell sites and coverage information of the user location includes at least one of the cell site information of at least method 300B or the coverage information of at least method 300B, and similar detailed description is therefore omitted.

In operation S406 of method 400, the customer care micro service 204 requests cell sites data from the inventory micro services 208b.

In some embodiments, the cell sites data includes at least one of the cell site information of at least method 300B, and similar detailed description is therefore omitted. In some embodiments, the cell site data of the user 302 includes a list of current cell sites and planned cell sites based on the users location 312.

In some embodiments, the cell sites of at least one of method 300B or 400 includes at least cell sites 322a-322i, 622, 722, 1022 or 1122.

In operation S407 of method 400, the inventory micro services 208b fetches the cell sites data from the database 206.

In operation S408 of method 400, the inventory micro services 208b receives the cell sites data from the database 206.

In operation S409 of method 400, the customer care micro service 204 receives the cell site data from the inventory micro services 208b.

In operation S410 of method 400, the customer care micro service 204 requests outage and intermittent alarm data of corresponding cell sites from the FM micro services 208c.

In some embodiments, the outage and intermittent alarm data of methods 300B and 400 includes FM data such as FM data 702, table 801 and outage alarms 330a-330d, 332a, 332b, 334a-334c, 830a-830c, and similar detailed description is therefore omitted.

In operation S411 of method 400, the FM micro services 208c fetches the outage and intermittent alarm data of the corresponding cell sites from the database 206.

In operation S412 of method 400, the FM micro services 208c receives the outage and intermittent alarm data of the corresponding cell sites from the database 206.

In operation S413 of method 400, the customer care micro service 204 receives the outage and intermittent alarm data of the corresponding cell sites from the FM micro services 208c.

In operation S414 of method 400, the customer care micro service 204 requests congestion data of corresponding cell sites from the PM micro services 208d.

In some embodiments, the congestion data of methods 300B and 400 includes PM data such as PM data 902, table 901, DL PRB Utilization parameter 910, VOLTE call drop ratio parameter 912, availability of the cell parameter 914, or DL user throughput parameter 916, and similar detailed description is therefore omitted.

In operation S415 of method 400, the PM micro services 208d fetches the congestion data of the corresponding cell sites from the database 206.

In operation S416 of method 400, the PM micro services 208d receives the congestion data of the corresponding cell sites from the database 206.

In operation S417 of method 400, the customer care micro service 204 receives the congestion data of the corresponding cell sites from the PM micro services 208d.

In operation S418 of method 400, the customer care micro service 204 requests coverage data of corresponding cell sites from a coverage micro services 208f.

In some embodiments, the coverage data of methods 300B and 400 includes at least one of coverage data 340, 342 or 344, and similar detailed description is therefore omitted. In some embodiments, the coverage data of methods 300B and 400 includes NW data such as NW data 1202, and similar detailed description is therefore omitted. In some embodiments, NW data 1202 includes download speed 1202a, upload speed 1202b, SINR 1202c, latency 1202d, RSRP 1202e, RSSI 1202f, Jitter 1202g, packet loss 1202h or the like.

In operation S419 of method 400, the coverage micro services 208f fetches the coverage data of the corresponding cell sites from the database 206.

In operation S420 of method 400, the coverage micro services 208f receives the coverage data of the corresponding cell sites from the database 206.

In operation S421 of method 400, the customer care micro service 204 receives the coverage data of the corresponding cell sites from the coverage micro services 208f.

In operation S422 of method 400, the cell site information and coverage information is displayed by the customer care web portal in the system. In some embodiments, the cell site information and coverage information is displayed based on the user location/user location details of the network customer 302.

In some embodiments, the cell site information and coverage information of the user location are displayed in the map region 310a of the customer care web portal 306, map region 610a of the customer care web portal 600, map region 710a of the customer care web portal 700, map region 1010a of the customer care web portal 1000 or map region 1110a of the customer care web portal 1100.

In some embodiments, the cell site information and coverage information of the user location are displayed in customer care web portal 800 or customer care web portal 900.

In operation S423 of method 400, the cell site information and coverage information is analyzed. In some embodiments, operation S423 includes operation S304 of method 300B, and similar detailed description is therefore omitted.

In operation S424 of method 400, details of at least one of the cause of the network issue or the solution of the network issue are provided to the network customer. In some embodiments, operation S424 includes the agent 304 explaining at least one of the cause of the network issue or the solution of the network issue to the network customer based on the analysis of the cell site information and coverage information. In some embodiments, operation S424 includes operation S305 of method 300B, and similar detailed description is therefore omitted.

In some embodiments, at least one of operation S401, S402, S403, S404, S423 or S424 is performed by a human user. In some embodiments, the performance of S401, S402, S403, S404, S423 or S424 is automated, and S401, S402, S403, S404, S423 or S424 is performed by a system such as system 1300 of FIG. 13.

In some embodiments, portions of at least one of operation S401, S402, S403, S404, S423 or S424 is performed by a human user. In some embodiments, portions of the performance of S401, S402, S403, S404, S423 or S424 is automated, and the portions of S401, S402, S403, S404, S423 or S424 is performed by a system such as system 1300 of FIG. 13.

In some embodiments, one or more of operations S423 or S424 is an embodiment of operation S304 of method 300B, and similar detailed description is therefore omitted.

In some embodiments, one or more of the operations of method 400 is not performed. By utilizing method 400, one or more elements of system 100, 200 or 300A is configured to achieve the benefits discussed within the present disclosure.

FIG. 5 is a flowchart of a method 500 of operating a system, in accordance with some embodiments.

Method 500 is an embodiment of one or more operations of method 300B of FIG. 3A, and similar detailed description is omitted.

In some embodiments, method 500 is a method of finding the users location when the agent 304 cannot find the details of the network customer 302 from the customer care web portal in operation S403 of method 400, and the agent 304 performs at least method 500 of FIG. 5, and similar detailed description is therefore omitted. In some embodiments, prior to execution of method 500, operation S402 of method 400 is performed, and similar detailed description is therefore omitted. In some embodiments, after execution of method 500, operation 406 proceeds to operation S404 of method 400, and similar detailed description is therefore omitted.

In some embodiments, FIG. 5 is a flowchart of a method 500 of operating system 100 of FIG. 1, system 200 of FIG. 2 or system 300A of FIG. 3A, and similar detailed description is therefore omitted. It is understood that additional operations may be performed before, during, and/or after the method 500 depicted in FIG. 5, and that some other operations may only be briefly described herein. In some embodiments, other order of operations of method 500 is within the scope of the present disclosure. In some embodiments, one or more operations of method 500 are not performed.

Method 500 includes exemplary operations, but the operations are not necessarily performed in the order shown. Operations may be added, replaced, changed order, and/or eliminated as appropriate, in accordance with the spirit and scope of disclosed embodiments. It is understood that method 500 utilizes features of one or more of system 100, 200 or 300A or method 300B.

In operation 502 of method 500, the agent 304 tells the network user 302 to download the NW application on the UE 110.

In operation 504 of method 500, network user 302 downloads the NW application to the UE 110.

In operation 506 of method 500, the NW application captures the users location or the location of the UE 110.

In some embodiments, one or more of the operations of method 500 is not performed. By utilizing method 500, one or more elements of system 100, 200 or 300A is configured to achieve the benefits discussed within the present disclosure.

FIG. 6 is a diagram of a customer care web portal 600 of a system, in accordance with some embodiments.

Customer care web portal 600 is a variation of customer care web portal 310 of FIG. 3, and similar detailed description is omitted. In some embodiments, customer care web portal 600 is generated by at least one of system 100, 200 or 300A, and similar detailed description is omitted.

Customer care web portal 600 includes a map 610a, an MSISDN field 602 of user 302, a phone type OS field 604, a user location details field 610, a location network performance field 650, a summary field 660 and a last speed test field 670.

In some embodiments, map 610a is a variation of region 310a, and similar detailed description is omitted.

Map 610a includes cell site information and coverage information of a user location 612. The user location 612 is shown by a pin drop on map 610a. In some embodiments, when agent 304 clicks on the user location 612, then a location window 680 opens on the map 610a. Location window 680 displays location information of user 302. In some embodiments, location information includes the address of the user 302, the latitude and longitude of the user 302, the time that the location information is captured by NW, a distance from the user location to the nearest cell site, a frequency band of the cell site, and a cell site identification (e.g., BTS).

The cell site information of map 610a includes the one or more cell sites 622 on map 610a.

The coverage information of map 610a includes at least one of coverage data 640, 642 or 644. In some embodiments, coverage data 640, 642 or 644 is similar to corresponding coverage data 340, 342 or 344, and similar detailed description is omitted. In some embodiments, cell sites 622 is similar to corresponding cell sites 322, and similar detailed description is omitted.

Coverage data 640 includes coverage data region 640a.

Coverage data 642 includes coverage data regions 642a, 642b and 642c.

Coverage data 644 includes coverage data region 644a.

The coverage information of map 610a further includes outage alarm 630. In some embodiments, outage alarm 630 is similar to corresponding outage alarm 330, and similar detailed description is omitted. Outage alarm 630 includes outage alarm 630a.

The MSISDN field 602 is a field where the agent 304 can enter the MSISDN of the user 302.

The phone type OS field 604 is a field where the agent 304 can enter the OS of the UE 110 of the user 302.

The user location details field 610 is a field where the agent 304 can select one of the last location 1014 of the user 302, the home location 1010 of the user 302 or the work location 1012 of the user 302.

The location network performance field 650 is a field that displays the location network performance. The location network performance field 650 includes an Outage Field 650a, a Coverage field 650b and a Congestion field 650c.

Outage Field 650a is a field that displays FM data (e.g., outages) of the cell sites within the first distance DI of the users location 612. In some embodiments, the FM data includes FM data 702 or table 802.

In some embodiments, the FM data in map 610a includes whether any outages have occurred, and a number of the cell sites shown in map 610a that have had any current outages or any outages in a first window. In some embodiments, the first window is 24 hours. Other numbers from the first window within the scope of the present disclosure.

Coverage field 650b is a field that displays coverage data of the cell sites within the first distance DI of the users location 612. In some embodiments, the coverage data includes coverage data 340, 342 or 344. In some embodiments, the coverage data includes different sub-divided coverage quality categories based on the user location. In some embodiments, the different sub-divided coverage quality categories include at least one of fair, good, weak outdoor, good outdoor, bad outdoor, weak indoor, good indoor, bad indoor or no outdoor. Other numbers of at least one of coverage data 340, 342 or 344, coverage regions or coverage quality are within the scope of the present disclosure.

Congestion field 650c is a field that displays PM data of the cell sites within the first distance DI of the users location 612.

In some embodiments, the PM data includes PM data 902. In some embodiments, the PM data includes KPIs of one or more cell sites 322 or the UE 110. In some embodiments, PM data includes congestion information of one or more cell sites 322. In some embodiments, PM data includes whether the current cell site is congested. In some embodiments, the congestion information or the PM data 902 includes DL PRB Utilization parameter 910, VOLTE call drop ratio parameter 912, availability of the cell parameter 914 or DL user throughput parameter 916.

In some embodiments, the PM data in map 610a includes whether congestion has occurred for the cell sites shown in map 610a, and if so, what degree of congestion has occurred. In some embodiments, the degree of congestion includes no congestion, some congestion and high congestion. In some embodiments, some congestion is congestion less than high congestion, and some congestion is greater than no congestion.

Other types of congestion and numbers of congestion are within the scope of the present disclosure.

The summary field 660 is a field that displays a summary of user 302. In some embodiments, the summary of user 302 includes a mobile number of user 302 and an international mobile subscriber identity (IMSI) of user 302.

The last speed test field 670 is a field that displays the results of the most recent speed test captured by the NW micro service 208e. In some embodiments, the most recent speed test is run on the UE 110 by the user 302 by the NW app, and the results of the speed test are shared with the NW micro service 208e. The last speed test field 670 includes the download speed of the UE 110, the upload speed of the UE 110 and the time of the speed test. Other parameters for the last speed test field 670 are within the scope of the present disclosure.

In some embodiments, one or more of the fields in customer care web portal 600 is not included. By utilizing customer care web portal 600, one or more elements of system 100, 200 or 300A is configured to achieve the benefits discussed within the present disclosure.

Other configurations or number of elements in customer care web portal 600 are within the scope of the present disclosure.

FIG. 7 is a diagram of a customer care web portal 700 of a system, in accordance with some embodiments.

In some embodiments, FIG. 7 includes operations S702 and S704 that are part of a method 701 utilized to generate a location window 780, and to generate an Alarm History Window (e.g., shown as customer care web portal 800 in FIG. 8). In some embodiments, method 701 is an embodiment of operation S303, and similar detailed description is therefore omitted.

In some embodiments, FIG. 7 includes operations S702 and S704 that are part of a method 701 utilized to generate a location window 780, and to generate a Performance Management Window (e.g., shown as customer care web portal 900 in FIG. 9). In some embodiments, method 701 is an embodiment of operation S303, and similar detailed description is therefore omitted.

Customer care web portal 700 is a variation of customer care web portal 310 or 600, and similar detailed description is omitted. In some embodiments, customer care web portal 700 is generated by at least one of system 100, 200 or 300A, and similar detailed description is omitted.

Customer care web portal 700 includes a map 710a. In some embodiments, map 710a is a variation of region 310a or map 610a, and similar detailed description is omitted.

Map 710a includes cell site information and coverage information of a user location 712. In some embodiments, user location 712 is similar to user location 612, and similar detailed description is therefore omitted.

The user location 712 is shown by a pin drop on map 710a. For example, in some embodiments, after agent 304 searches for the MSISDN 602 of the user 302 or the cell site id, a pin is dropped on the map 710a in operation S702 showing the users location 712, and when agent 304 clicks on the user location 612, then a location window 780 opens on the map 710a. Location window 780 displays location information of user 302. In some embodiments, location information includes the address of the user 302, the latitude and longitude of the user 302, the time that the location information is captured by NW, a distance from the user location to the nearest cell site, a frequency band of the cell site, and a cell site identification (e.g., BTS). In some embodiments, the location information shows location information of cell sites 722.

The cell site information of map 710a includes one or more cell sites of cell sites 722 on map 710a. In some embodiments, cell sites 722 are similar to cell sites 322 or 622, and similar detailed description is therefore omitted.

Cell sites 722 includes at least one of cell sites 722a, 722b, 722c, 722d, 722e or 722f. Each cell site in cell sites 722 includes three or more cells. Other numbers of cells for each cell site in cell sites 722 are within the scope of the present disclosure.

Each cell in cell sites 722a and 722b have active outage alarms.

Two cells in cell site 722c has no active outage alarms and no outage alarms in the first window, and one cell in cell site 722c has an active outage alarm.

Each cell in cell site 722d has no active outage alarms and no outage alarms in the first window.

Each cell in cell site 722e has outage alarms in the first window.

One cell in cell site 722f has no active outage alarms and no outage alarms in the first window, and two cells in cell site 722c has an active outage alarm.

Other numbers of cells having different outage alarms are within the scope of the present disclosure.

In some embodiments, when agent 304 clicks on site 722a in operation S704, then an Alarm History Window (e.g., shown as customer care web portal 800 in FIG. 8) opens over the map 710a or replaces the map 710a. In some embodiments, the Alarm History Window (e.g., shown as customer care web portal 800 in FIG. 8) opens adjacent to the map 710a. Other locations for the alarm history window are within the scope of the present disclosure.

In some embodiments, when agent 304 clicks on site 722a in operation S704, then a Performance Management Window (e.g., shown as customer care web portal 900 in FIG. 9) opens over the map 710a or replaces the map 710a. In some embodiments, the Performance Management Window (e.g., shown as customer care web portal 900 in FIG. 9) opens adjacent to the map 710a. Other locations for the Performance Management Window are within the scope of the present disclosure.

In some embodiments, one or more of the fields in customer care web portal 700 is not included. By utilizing customer care web portal 700, one or more elements of system 100, 200 or 300A is configured to achieve the benefits discussed within the present disclosure.

Other configurations or number of elements in customer care web portal 700 are within the scope of the present disclosure.

FIG. 8 is a diagram of a customer care web portal 800 of a system, in accordance with some embodiments.

In some embodiments, customer care web portal 800 is generated after execution of operations S702 and S704 of method, and similar detailed description is therefore omitted.

Customer care web portal 800 is a variation of customer care web portal 310, 600 or 700, and similar detailed description is omitted. In some embodiments, customer care web portal 800 is generated by operation S704 of method 701. In some embodiments, customer care web portal 800 is generated by at least one of system 100, 200 or 300A, and similar detailed description is omitted.

Customer care web portal 800 is an Alarm History Window for cell site 722a. In some embodiments, each cell site has a corresponding Alarm History Window similar to the Alarm History Window of FIG. 8, and similar detailed description is therefore omitted.

Customer care web portal 800 includes a table 801, an Alarm History field 850 and a Performance Management Field 852. In some embodiments, when agent 304 clicks on the Alarm History field 850, then table 801 is shown as the customer care web portal 800. In some embodiments, when agent 304 clicks on the Performance Management Field 852, then table 901 is shown as the customer care web portal 900.

Table 801 is a listing of each cell in the site cell 722a, and specifies whether the cell has an active outage alarm or outage alarms in the first window.

Table 801 includes a list of cell site identifiers (IDs) 822a, 822b and 822c for the corresponding cell of the cell site 722a, a frequency band of the corresponding cell site ID, a status of an outage 830a, 830b and 830c of the corresponding cell, a duration of the outage of the corresponding cell, a start time of the outage of the corresponding cell, an end date of the outage of the corresponding cell, and an end time of the outage of the corresponding cell.

Table 801 comprises 4 rows and 8 columns. Row 1 corresponds to the title fields of table 801.

Column 1 comprises cell site IDs of the cell. In some embodiments, the cell site IDs of the table 801 are useable to identify the corresponding cell. Column 2 comprises a frequency band of each corresponding cell site ID in column 1. Column 3 comprises a status of an outage of each corresponding cell in column 1. For example, column 3 specifies whether the corresponding cell has a current or active outage, had a previous outage in the first window or no outage. Column 4 comprises a duration of the outage of each corresponding cell in column 1. Column 5 comprises a start time of the outage of each corresponding cell in column 1. Column 6 comprises a start time of the outage of each corresponding cell in column 1. Column 7 comprises an end date of the outage of each corresponding cell in column 1. Column 8 comprises an end time of the outage of each corresponding cell in column 1.

Each entry in column 1 has a corresponding entry in column 2, a corresponding entry in column 3, a corresponding entry in column 4, a corresponding entry in column 5, a corresponding entry in column 6, a corresponding entry in column 7, and a corresponding entry in column 8, and vice versa.

In some embodiments, outage 830a, 830b and 830c corresponds to outage alarm 330a-330d, 332a, 332b, 334a-334c, and similar detailed description is therefore omitted.

In some embodiments, table 801 is generated after execution of operations S702 and S704 of method, and similar detailed description is therefore omitted.

In some embodiments, table 801 is stored in memory 1304 of FIG. 13. In some embodiments, table 801 is generated by system 1300 of FIG. 13.

Other numbers of columns, other numbers of rows, or other types of data in table 801 are within the scope of the present disclosure.

In some embodiments, one or more of the fields in customer care web portal 800 is not included. By utilizing customer care web portal 800, one or more elements of system 100, 200 or 300A is configured to achieve the benefits discussed within the present disclosure.

Other configurations or number of elements in customer care web portal 800 are within the scope of the present disclosure.

FIG. 9 is a diagram of a customer care web portal 900 of a system, in accordance with some embodiments.

In some embodiments, customer care web portal 900 is generated after execution of operations S702 and S704 of method, and similar detailed description is therefore omitted.

Customer care web portal 900 is a variation of customer care web portal 310, 600, 700 or 800, and similar detailed description is omitted. In some embodiments, customer care web portal 900 is generated by operation S704 of method 701. In some embodiments, customer care web portal 900 is generated by at least one of system 100, 200 or 300A, and similar detailed description is omitted.

Customer care web portal 900 is an Alarm History Window for cell site 722a. In some embodiments, each cell site has a corresponding Alarm History Window similar to the Alarm History Window of FIG. 9, and similar detailed description is therefore omitted.

Customer care web portal 900 includes a table 901, Alarm History field 850 and Performance Management Field 852. In some embodiments, when agent 304 clicks on the Alarm History field 850, then table 901 is shown as the customer care web portal 900. In some embodiments, when agent 304 clicks on the Performance Management Field 852, then table 901 is shown as the customer care web portal 900.

Table 901 is a listing of the cell ID in the site cell 722a, and specifies the performance of the site cell 722a. In some embodiments, a site includes one or more cells. In some embodiments, one site may include multiple cell identifications (IDs) based upon the site's configuration. In some embodiments, a site ID is a unique key or ID that is useable to identify one or more sites from multiple sites within the network. In some embodiments, the cell ID is useable to identify one cell from multiple cells within a single site.

Table 901 includes a cell ID for the corresponding cell site 722a, a DL PRB utilization 910 of the corresponding cell ID, a VOLTE call drop ratio 912 of the corresponding cell ID, an availability of the cell 914 of the corresponding cell ID, and a DL user throughput 916 of the corresponding cell ID.

Table 901 comprises 2 rows and 5 columns. Row 1 corresponds to the title fields of table 901.

Column 1 comprises cell IDs of each cell site. In some embodiments, the cell IDs of the table 901 are useable to identify the corresponding cell. Column 2 comprises DL PRB utilization 910 of each corresponding cell ID in column 1. Column 3 comprises a VOLTE call drop ratio of each corresponding cell ID in column 1. Column 4 comprises an availability of each corresponding cell ID in column 1. Column 5 comprises a DL user throughput of each corresponding cell ID in column 1.

Each entry in column 1 has a corresponding entry in column 2, a corresponding entry in column 3, a corresponding entry in column 4, and a corresponding entry in column 5, and vice versa.

In some embodiments, table 901 includes congestion information or PM data 902 of one or more cell sites 322

In some embodiments, table 901 is generated after execution of operations S702 and S704 of method, and similar detailed description is therefore omitted.

In some embodiments, table 901 is stored in memory 1304 of FIG. 13. In some embodiments, table 901 is generated by system 1300 of FIG. 13.

Other numbers of columns, other numbers of rows, or other types of data in table 901 are within the scope of the present disclosure.

In some embodiments, one or more of the fields in customer care web portal 900 is not included. By utilizing customer care web portal 900, one or more elements of system 100, 200 or 300A is configured to achieve the benefits discussed within the present disclosure.

Other configurations or number of elements in customer care web portal 900 are within the scope of the present disclosure.

FIG. 10 is a diagram of a customer care web portal 1000 of a system, in accordance with some embodiments.

In some embodiments, FIG. 10 includes operation S1002 that is part of a method 1001 utilized to set or change the user location through a drop down window, and selecting the home location 1010 of the network customer, the work location 1012 of the network customer or the last location 1014 (FIG. 10) of the network customer. In some embodiments, method 1001 is an embodiment of operation S303, and similar detailed description is therefore omitted.

Customer care web portal 1000 is a variation of customer care web portal 310, 600 or 700, and similar detailed description is omitted. In some embodiments, customer care web portal 1000 is generated by at least one of system 100, 200 or 300A, and similar detailed description is omitted.

Customer care web portal 1000 includes a map 1010a. In some embodiments, map 1010a is a variation of region 310a, map 610a or 710a, and similar detailed description is omitted.

Map 1010a includes cell site information and coverage information of a user location 1112. In some embodiments, user location 1112 is similar to user location 612 or 712, and similar detailed description is therefore omitted.

The user location 1112 is shown by a pin drop on map 1010a. For example, in some embodiments, after agent 304 selects the home location 1010, the work location 1012 or the last location 1014 of the network customer in operation S1002, a pin is dropped on the map 1010a showing the selected users location, and when agent 304 clicks on the user location 1112, then a location window 1080 opens on the map 1010a.

Location window 1080 displays location information of user 302. Location window 1080 is similar to location window 680 or 780, and similar detailed description is therefore omitted.

Location window 1080 corresponds to the address of the home location 1010 of the network customer, the work location 1012 of the network customer or the last location 1014 of the network customer based on the drop down window selection of the home location 1010, the work location 1012 or the last location 1014 of the network customer by agent 304.

The cell site information of map 1010a includes one or more cell sites of cell sites 1022 on map 1010a. In some embodiments, cell sites 1022 are similar to cell sites 322, 622 or 722, and similar detailed description is therefore omitted.

Cell sites 1022 includes at least one of cell sites 1022a, 1022b or 1022c. Each cell site in cell sites 1022 includes three or more cells. Other numbers of cells for each cell site in cell sites 1022 are within the scope of the present disclosure.

Each cell in cell sites 1022a, 1022b and 1022c have outage alarms.

In some embodiments, one or more of the fields in customer care web portal 1000 is not included. By utilizing customer care web portal 1000, one or more elements of system 100, 200 or 300A is configured to achieve the benefits discussed within the present disclosure.

Other configurations or number of elements in customer care web portal 1000 are within the scope of the present disclosure.

FIG. 11 is a diagram of a customer care web portal 1100 of a system, in accordance with some embodiments.

In some embodiments, FIG. 11 includes operations S1102 and S1104 that are part of a method 1101 to click on an insight field 1190 to display a location network performance field 1150, a summary field 1160 and a last speed test field 1170. In some embodiments, location network performance field 1150 is similar to location network performance field 650, summary field 1160 is similar to summary field 660, last speed test field 670 is similar to last speed test field 1170, and similar detailed description is therefore omitted.

In operation S1102, the agent 304 clicks on the insight field 1190 to display the location network performance field 1150, the summary field 1160 and the last speed test field 1170.

In operation S1104, the agent 304 clicks on the location network performance field 1150 to display the network performance in map 1110a. In some embodiments, the network performance is shown in map 1110a by coloring the network performance based on color key 310b of the coverage data, the color coding of cell sites 322a-322i that corresponds to outage alarms 330a-330d, 332a, 332b, 334a-334c, and congestion details.

In some embodiments, if agent 304 clicks on the last speed test field 1170, then a Speed Test Window (e.g., shown as customer care web portal 1200 in FIG. 12) opens over the map 1110a or replaces the map 1110a. In some embodiments, the Speed Test Window (e.g., shown as customer care web portal 1200 in FIG. 12) opens adjacent to the map 1110a. Other locations for the Speed Test Window Performance Management Window are within the scope of the present disclosure.

The location network performance field 1150 includes an Outage Field 1150a, a Coverage field 1150b and a Congestion field 1150c.

In some embodiments, the Outage Field 1150a is similar to Outage Field 650a, the Coverage Field 1150b is similar to Coverage Field 650b, the Congestion field 1150c is similar to Congestion field 650c, and similar detailed description is therefore omitted.

In some embodiments, method 1101 is an embodiment of operation S303, and similar detailed description is therefore omitted.

Customer care web portal 1100 is a variation of customer care web portal 310, 600, 700 or 1000, and similar detailed description is omitted. In some embodiments, customer care web portal 1100 is generated by at least one of system 100, 200 or 300A, and similar detailed description is omitted.

Customer care web portal 1100 includes a map 1110a. In some embodiments, map 1110a is a variation of region 310a, map 610a or 710a, and similar detailed description is omitted.

Map 1110a includes cell site information and coverage information of a user location 1112. In some embodiments, user location 1112 is similar to user location 612 or 712, and similar detailed description is therefore omitted.

The user location 1112 is shown by a pin drop on map 1110a. For example, in some embodiments, after agent 304 selects the home location 1010, the work location 1012 or the last location 1014 of the network customer in operation S1002, a pin is dropped on the map 1110a showing the selected users location, and when agent 304 clicks on the user location 1112, then a location window 1180 opens on the map 1110a.

Location window 1180 displays location information of user 302. Location window 1180 is similar to location window 680 or 780, and similar detailed description is therefore omitted

The cell site information of map 1110a includes one or more cell sites of cell sites 1122 on map 1110a. In some embodiments, cell sites 1122 are similar to cell sites 322, 622, 722 or 1022, and similar detailed description is therefore omitted.

In some embodiments, one or more of the fields in customer care web portal 1100 is not included. By utilizing customer care web portal 1100, one or more elements of system 100, 200 or 300A is configured to achieve the benefits discussed within the present disclosure.

Other configurations or number of elements in customer care web portal 1100 are within the scope of the present disclosure.

FIG. 12 is a diagram of a customer care web portal 1200 of a system, in accordance with some embodiments.

Customer care web portal 1200 is a variation of customer care web portal 310, 600, 700, 1000 or 1100, and similar detailed description is omitted. In some embodiments, customer care web portal 1200 is generated by at least one of system 100, 200 or 300A, and similar detailed description is omitted.

In some embodiments, customer care web portal 1200 is generated after the agent 304 clicks on the last speed test field 1170 in customer care web portal 1100.

Customer care web portal 1200 includes different speed test parameters of the last performed speed test. In some embodiments, the different speed test parameters of the last performed speed test include NW data 1202. NW data 1202 includes download speed 1202a, upload speed 1202b, SINR 1202c, latency 1202d, RSRP 1202e, RSSI 1202f, Jitter 1202g, packet loss 1202h or the like.

In some embodiments, FIG. 12 includes operations S1202 and S1204 that are part of a method 1201 to execute a speed test on the UE 110.

In operation S1202, the agent 304 clicks on the send SMS button 1292 to send a SMS to the UE that contains a NW link. In some embodiments, the NW link is used by the user 302 to download the NW application. Once the application is downloaded by the user 302, then the agent 304 can execute a speed test of the UE in operation S1204.

In operation S1204, the agent 304 clicks on the speed test button 1290 to execute the speed test of the UE. In some embodiments, if agent 304 clicks on the speed test button 1290, then the agent 304 is redirected to a start test window to conduct the speed test.

In some embodiments, method 1201 is an embodiment of operation S303, and similar detailed description is therefore omitted.

In some embodiments, one or more of the fields in customer care web portal 1200 is not included. By utilizing customer care web portal 1200, one or more elements of system 100, 200 or 300A is configured to achieve the benefits discussed within the present disclosure.

Other configurations or number of elements in customer care web portal 1200 are within the scope of the present disclosure.

FIG. 13 is a schematic view of a system 1300, in accordance with some embodiments.

In some embodiments, system 1300 is an embodiment of one or more elements in system 100, 200 or 300, and similar detailed description is therefore omitted.

In some embodiments, system 1300 is configured to perform one or more operations of methods 300B, 400, 500, 701, 1001, 1101 or 1201.

System 1300 includes a hardware processor 1302 and a non-transitory, computer readable storage medium 1304 (e.g., memory 1304) encoded with, i.e., storing, the computer program code 1306, i.e., a set of executable instructions 1306. Computer readable storage medium 1304 is configured for interfacing with at least one element of system 100, 200 or 300, and similar detailed description is therefore omitted.

The processor 1302 is electrically coupled to the computer readable storage medium 1304 by a bus 1308. The processor 1302 is also electrically coupled to an I/O interface 1310 by bus 1308. A network interface 1312 is also electrically connected to the processor 1302 by bus 1308. Network interface 1312 is connected to at least one of network 1314, so that processor 1302 and computer readable storage medium 1304 are capable of connecting to external elements by network 1314. The processor 1302 is configured to execute the computer program code 1306 encoded in the computer readable storage medium 1304 in order to cause system 1300 to be usable for performing a portion or all of the operations as described in at least methods 300B, 400, 500, 701, 1001, 1101 or 1201. In some embodiments, network 1314 is not part of system 1300.

In some embodiments, the processor 1302 is a central processing unit (CPU), a multi-processor, a distributed processing read circuit, an application specific integrated circuit (ASIC), and/or a suitable processing unit.

In some embodiments, the computer readable storage medium 1304 is an electronic, magnetic, optical, electromagnetic, infrared, and/or a semiconductor read circuit (or apparatus or device). For example, the computer readable storage medium 1304 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 1304 includes a compact disk-read only memory (CD-ROM), a compact disk-read/write (CD-R/W), and/or a digital video disc (DVD).

In some embodiments, forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

In some embodiments, the storage medium 1304 stores the computer program code 1306 configured to cause system 1300 to perform one or more operations of at least methods 300B, 400, 500, 701, 1001, 1101 or 1201. In some embodiments, the storage medium 1304 also stores information used for performing at least methods 300B, 400, 500, 701, 1001, 1101 or 1201 as well as information generated during performing at least methods 300B, 400, 500, 701, 1001, 1101 or 1201, such as customer care web portal 1316, Map 1318, user interface 1324, user parameters 1326, and/or a set of executable instructions to perform one or more operations of at least methods 300B, 400, 500, 701, 1001, 1101 or 1201.

In some embodiments, the storage medium 1304 stores instructions (e.g., computer program code 1306) for interfacing with at least one or more elements of system 100, 200 or 300. The instructions (e.g., computer program code 1306) enable processor 1302 to generate instructions readable by at least one or more of element of system 100, 200 or 300 to effectively implement one or more operations of at least methods 300B, 400, 500, 701, 1001, 1101 or 1201 during operation of system 201.

System 1300 includes I/O interface 1310. I/O interface 1310 is coupled to external circuitry. In some embodiments, I/O interface 1310 includes a keyboard, keypad, mouse, trackball, trackpad, and/or cursor direction keys for communicating information and commands to processor 1302.

System 1300 also includes network interface 1312 coupled to the processor 1302. Network interface 1312 allows system 1300 to communicate with network 1314, to which one or more other computer read circuits are connected. Network interface 1312 includes wireless network interfaces such as OFDMA, CDMA, BLUETOOTH, WIFI, WIMAX, GPRS, or WCDMA; or wired network interface such as ETHERNET, USB, or IEEE-802.11. In some embodiments, at least methods 300B, 400, 500, 701, 1001, 1101 or 1201 is implemented in two or more systems 1300, and information such as customer care web portal, Map and user interface are exchanged between different systems 1300 by network 1314.

System 1300 is configured to receive information related to a customer care web portal through I/O interface 1310 or network interface 1312. The information is transferred to processor 1302 by bus 1308, and is then stored in computer readable medium 1304 as customer care web portal 1316. In some embodiments, customer care web portal 1316 corresponds to at least one of customer care web portal 310, 600, 700, 800, 900, 1000, 1100 or 1200, and similar detailed description is therefore omitted. System 1300 is configured to receive information related to Map through I/O interface 1310 or network interface 1312. The information is stored in computer readable medium 1304 as Map 1318. In some embodiments, Map 1318 corresponds to at least or more of map 310a, 610a, 710a, 1010a or 1110a, and similar detailed description is therefore omitted. System 1300 is configured to receive information related to a user interface through I/O interface 1310 or network interface 1312. The information is stored in computer readable medium 1304 as user interface 1324. System 1300 is configured to receive information related to user parameters through I/O interface 1310 or network interface 1312. The information is stored in computer readable medium 1304 as user parameters 1326. In some embodiments, user parameters 1326 corresponds to at least one or more columns of table 801 or 901, NW data 1202, or one or more of the parameters in FIGS. 1-12, or methods 300B, 400, 500, 701, 1001, 1101 or 1201, and similar detailed description is therefore omitted.

In some embodiments, at least methods 300B, 400, 500, 701, 1001, 1101 or 1201 is implemented as a standalone software application for execution by a processor. In some embodiments, at least methods 300B, 400, 500, 701, 1001, 1101 or 1201 is implemented as corresponding software applications for execution by one or more processors.

In some embodiments, at least method methods 300B, 400, 500, 701, 1001, 1101 or 1201 is implemented as a software application that is a part of an additional software application. In some embodiments, at least method methods 300B, 400, 500, 701, 1001, 1101 or 1201 is implemented as a plug-in to a software application.

In some embodiments, at least method methods 300B, 400, 500, 701, 1001, 1101 or 1201 is implemented as a software application that is a portion of a customer care tool. In some embodiments, the customer care tool is used to plan, deploy, monitor and optimize customer care of one or more cellular networks.

In some embodiments, one or more of the operations of methods 300B, 400, 500, 701, 1001, 1101 or 1201 is not performed.

It will be readily seen by one of ordinary skill in the art that one or more of the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

One aspect of this description relates to a method. In some embodiments, the method includes receiving, by an agent, a complaint of a network issue of a network customer, searching, by the agent, for details of the network customer in a system, finding user location details of the network customer in the system, and displaying, by a customer care web portal in the system, cell site information and coverage information based on the user location details of the network customer. The method further includes determining at least one of a cause of the network issue or a solution of the network issue based on the cell site information and coverage information, and providing details of at least one of the cause of the network issue or the solution of the network issue to the network customer.

Another aspect of this description relates to an apparatus that includes a memory having non-transitory instructions stored therein, and a processor coupled to the memory, and being configured to execute the non-transitory instructions, thereby causing the apparatus to receive a complaint of a network issue of a network customer, search for details of the network customer in a system, find user location details of the network customer in the system, and display, by a customer care web portal of the apparatus, cell site information and coverage information based on the user location details of the network customer, determine at least one of a cause of the network issue or a solution of the network issue based on the cell site information and coverage information, and provide details of at least one of the cause of the network issue or the solution of the network issue to the network customer.

Still another aspect of this description relates to a computer-readable medium. In some embodiments, the computer-readable medium includes instructions executable by a controller of a system to cause the system to perform operations including receiving a complaint of a network issue of a network customer, searching for details of the network customer in a system, finding user location details of the network customer in the system, and displaying, by a customer care web portal in the system, cell site information and coverage information based on the user location details of the network customer, determining at least one of a cause of the network issue or a solution of the network issue based on the cell site information and coverage information, and providing details of at least one of the cause of the network issue or the solution of the network issue to the network customer.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
receiving, by an agent, a complaint of a network issue of a network customer;
searching, by the agent, for details of the network customer in a system;
finding user location details of the network customer in the system, and displaying, by a customer care web portal in the system, cell site information and coverage information based on the user location details of the network customer;
determining at least one of a cause of the network issue or a solution of the network issue based on the cell site information and coverage information; and
providing details of at least one of the cause of the network issue or the solution of the network issue to the network customer.

2. The method of claim 1, further comprising:
receiving, by the agent, the details of the network customer from the customer care web portal in the system.

3. The method of claim 1, wherein the finding user location details in the system, and displaying the cell site information and coverage information based on the user location details comprises:
requesting, by the customer care web portal, cell sites and coverage information of the user location from a customer care micro services.

4. The method of claim 3, wherein the requesting, by the customer care web, cell sites and coverage information of the user location from a customer care micro services comprises:
requesting, by the customer care micro service, cell sites data from an inventory micro services;
fetching, by the inventory micro services, the cell sites data from a database;
receiving, by the inventory micro services, the cell sites data from the database; and
receiving, by the customer care micro service, the cell site data from the inventory micro services.

5. The method of claim 4, wherein the requesting, by the customer care web, cell sites and coverage information of the user location from a customer care micro services further comprises:
requesting, by the customer care micro service, outage and intermittent alarm data of corresponding cell sites from a fault management (FM) micro services;
fetching, by the FM micro services, the outage and intermittent alarm data of the corresponding cell sites from the database;
receiving, by the FM micro services, the outage and intermittent alarm data of the corresponding cell sites from the database; and
receiving, by the customer care micro service, the outage and intermittent alarm data of the corresponding cell sites from the FM micro services.

6. The method of claim 5, wherein the requesting, by the customer care web, cell sites and coverage information of the user location from a customer care micro services further comprises:
requesting, by the customer care micro service, congestion data of corresponding cell sites from a performance management (PM) micro services;
fetching, by the PM micro services, the congestion data of the corresponding cell sites from the database;
receiving, by the PM micro services, the congestion data of the corresponding cell sites from the database; and
receiving, by the customer care micro service, the congestion data of the corresponding cell sites from the PM micro services.

7. The method of claim 6, wherein the requesting, by the customer care web, cell sites and coverage information of the user location from a customer care micro services further comprises:
requesting, by the customer care micro service, coverage data of corresponding cell sites from a coverage micro services;
fetching, by the coverage micro services, the coverage data of the corresponding cell sites from the database;
receiving, by the coverage micro services, the coverage data of the corresponding cell sites from the database; and
receiving, by the customer care micro service, the coverage data of the corresponding cell sites from the coverage micro services.

8. An apparatus, comprising:
a memory having non-transitory instructions stored therein; and
a processor coupled to the memory, and being configured to execute the non-transitory instructions, thereby causing the apparatus to:
receive a complaint of a network issue of a network customer;
search for details of the network customer in a system;
find user location details of the network customer in the system, and display, by a customer care web portal of the apparatus, cell site information and coverage information based on the user location details of the network customer;
determine at least one of a cause of the network issue or a solution of the network issue based on the cell site information and coverage information; and
provide details of at least one of the cause of the network issue or the solution of the network issue to the network customer.

9. The apparatus of claim 8, wherein the processor is further configured to execute the non-transitory instructions, thereby further causing the apparatus to:
receive the details of the network customer.

10. The apparatus of claim 8, wherein the non-transitory instructions that cause the apparatus to find the user location details in the system, and display the cell site information and coverage information based on the user location details, the processor being further configured to cause the apparatus to:
request cell sites and coverage information of the user location.

11. The apparatus of claim 10, wherein the non-transitory instructions that cause the apparatus to request the cell sites and coverage information of the user location, the processor being further configured to cause the apparatus to:
request cell sites data from an inventory micro services;
fetch, by the inventory micro services, the cell sites data from a database;
receive, by the inventory micro services, the cell sites data from the database; and
receive the cell site data from the inventory micro services.

12. The apparatus of claim 11, wherein the non-transitory instructions that cause the apparatus to request the cell sites and coverage information of the user location, the processor being further configured to further cause the apparatus to:
request outage and intermittent alarm data of corresponding cell sites from a fault management (FM) micro services;
fetch, by the FM micro services, the outage and intermittent alarm data of the corresponding cell sites from the database;
receive, by the FM micro services, the outage and intermittent alarm data of the corresponding cell sites from the database; and
receive the outage and intermittent alarm data of the corresponding cell sites from the FM micro services.

13. The apparatus of claim 12, wherein the non-transitory instructions that cause the apparatus to request the cell sites and coverage information of the user location, the processor being further configured to further cause the apparatus to:
request congestion data of corresponding cell sites from a performance management (PM) micro services;
fetch, by the PM micro services, the congestion data of the corresponding cell sites from the database;
receive, by the PM micro services, the congestion data of the corresponding cell sites from the database; and
receive the congestion data of the corresponding cell sites from the PM micro services.

14. The apparatus of claim 13, wherein the non-transitory instructions that cause the apparatus to request the cell sites and coverage information of the user location, the processor being further configured to further cause the apparatus to:
request coverage data of corresponding cell sites from a coverage micro services;
fetch, by the coverage micro services, the coverage data of the corresponding cell sites from the database;
receive, by the coverage micro services, the coverage data of the corresponding cell sites from the database; and
receive the coverage data of the corresponding cell sites from the coverage micro services.

15. A computer-readable medium including instructions executable by a controller of a system to cause the system to perform operations comprising:
receiving a complaint of a network issue of a network customer;
searching for details of the network customer in a system;
finding user location details of the network customer in the system, and displaying, by a customer care web portal in the system, cell site information and coverage information based on the user location details of the network customer;
determining at least one of a cause of the network issue or a solution of the network issue based on the cell site information and coverage information; and
providing details of at least one of the cause of the network issue or the solution of the network issue to the network customer.

16. The computer-readable medium of claim 15, wherein the instructions executable by the controller of the system cause the controller to perform operations comprising finding the user location details, and displaying the cell site information and coverage information based on the user location details, the controller being further configured to perform operations comprising:
requesting, by the customer care web portal, cell sites and coverage information of the user location.

17. The computer-readable medium of claim 16, wherein the instructions executable by the controller of the system cause the controller to perform operations comprising requesting the cell sites and coverage information of the user location, the controller being further configured to perform operations comprising:
requesting cell sites data from an inventory micro services;
fetching, by the inventory micro services, the cell sites data from a database;
receiving, by the inventory micro services, the cell sites data from the database; and
receiving the cell site data from the inventory micro services.

18. The computer-readable medium of claim 17, wherein the instructions executable by the controller of the system cause the controller to perform operations comprising requesting the cell sites and coverage information of the user location, the controller being further configured to perform operations comprising:
requesting outage and intermittent alarm data of corresponding cell sites from a fault management (FM) micro services;
fetching, by the FM micro services, the outage and intermittent alarm data of the corresponding cell sites from the database;
receiving, by the FM micro services, the outage and intermittent alarm data of the corresponding cell sites from the database; and
receiving the outage and intermittent alarm data of the corresponding cell sites from the FM micro services.

19. The computer-readable medium of claim 18, wherein the instructions executable by the controller of the system cause the controller to perform operations comprising requesting the cell sites and coverage information of the user location, the controller being further configured to perform operations comprising:
requesting congestion data of corresponding cell sites from a performance management (PM) micro services;
fetching, by the PM micro services, the congestion data of the corresponding cell sites from the database;
receiving, by the PM micro services, the congestion data of the corresponding cell sites from the database; and
receiving the congestion data of the corresponding cell sites from the PM micro services.

20. The computer-readable medium of claim 19, wherein the instructions executable by the controller of the system cause the controller to perform operations comprising requesting the cell sites and coverage information of the user location, the controller being further configured to perform operations comprising:
requesting coverage data of corresponding cell sites from a coverage micro services;
fetching, by the coverage micro services, the coverage data of the corresponding cell sites from the database;
receiving, by the coverage micro services, the coverage data of the corresponding cell sites from the database; and
receiving the coverage data of the corresponding cell sites from the coverage micro services.
